(19) United States
(12) Patent Application Publication
(10) Pub. No.: US 2024/0236972 A9
(43) Pub. Date: Jul. 11, 2024

(54) TECHNIQUES FOR MULTIPLEXING UPLINK CONTROL INFORMATION

(71) Applicant: QUALCOMM Incorporated, San Diego, CA (US)

(72) Inventors: Yan ZHOU, San Diego, CA (US); Konstantinos DIMOU, New York, NY (US); Yi HUANG, San Diego, CA (US); Tao LUO, San Diego, CA (US); Mostafa KHOSHNEVISAN, San Diego, CA (US); Kazuki TAKEDA, Minato-ku (JP)

(21) Appl. No.: 18/547,490

(22) PCT Filed: Apr. 5, 2022
(86) PCT No.: PCT/US2022/023542

§ 371 Date: Aug. 22, 2023

(30) Foreign Application Priority Data
Apr. 6, 2021 (GR) 20210100231

(51) Int. Cl. H04W 72/11; H04W 72/044; H04W 72/1268; H04W 72/21

(52) U.S. Cl. CPC H04W 72/11; H04W 72/0466; H04W 72/1268; H04W 72/21

(57) ABSTRACT

Methods, systems, and devices for wireless communications are described. A user equipment (UE) may monitor for one or more semi-persistent scheduling (SPS) transmissions according to one or more SPS configurations. The UE may generate a set of feedback bits associated with the SPS transmissions, the feedback bits scheduled for transmission in a first set of uplink symbols. The UE may receive control signaling that changes an availability of the first set of uplink symbols for transmission of the set of feedback bits, and then defer transmission of the set of feedback bits to a second set of uplink symbols. The UE may determine whether to transmit at least a portion of the set of feedback bits in the second set of uplink symbols, and may transmit at least the portion of the set of feedback bits in the second set of uplink symbols and communicate in accordance with the determining.

### CROSS REFERENCE

The present Application is a 371 national stage filing of International PCT Application No. PCT/US2022/023542 by ZHOU et al. entitled “TECHNIQUES FOR MULTIPLEXING UPLINK CONTROL INFORMATION,” filed Apr. 5, 2022; and claims priority to Greece Patent Application No. 20210100231 by DIMOU et al., entitled “TECHNIQUES FOR MULTIPLEXING UPLINK CONTROL INFORMATION,” filed Apr. 6, 2021, each of which is assigned to the assignee hereof, and each of which is expressly incorporated by reference in its entirety herein.

### TECHNICAL FIELD

The following relates to wireless communications, including techniques for multiplexing uplink control information.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations (or other network entities) or one or more network access nodes, each simultaneously supporting communication for multiple communication devices, which may be otherwise known as user equipment (UE).

In some wireless communications systems, a UE may be configured to transmit feedback based on monitoring for transmissions according to one or more semi-persistent scheduling (SPS) configurations. But in certain situations, conflicting transmissions may make it difficult to transmit the feedback.

### SUMMARY

The described techniques relate to improved methods, systems, devices, and apparatuses that support techniques for multiplexing uplink control information. Generally, the described techniques provide for enabling a user equipment (UE) to multiplex deferred and non-deferred existing uplink control information (UCI) bits in the same slot. A UE may monitor for semi-persistent scheduling (SPS) transmissions from a network entity. Based on the monitoring, the UE may generate SPS feedback bits (e.g., acknowledgment (ACK) or negative ACK (NACK) bits) scheduled for transmission to the network entity in a first set of uplink symbols (e.g., a first slot format). In some cases, a collision may occur during transmission if a physical uplink control channel (PUCCH) carrying SPS feedback bits at least partially overlaps with downlink symbols. Because of the collision, the UE may defer transmission of the feedback bits to a second set of uplink symbols (e.g., a second slot format) to avoid the collision.

In some cases, the second set of uplink symbols may already carry existing, non-deferred UCI bits to be transmitted, and the UE may multiplex the deferred SPS feedback bits and the non-deferred UCI bits in the target slot for transmitting. For example, if a candidate target slot already has existing, non-deferred UCI bits, it may not accommodate the non-deferred UCI bits and the deferred feedback bits (e.g., the size of the feedback bits and UCI bits combined may be greater than an allocation size of the second set of uplink symbols). In some cases, the UE may cancel (e.g., drop) transmission of some or all of the UCI bits or the feedback bits, or may continue to check the next slot for transmitting all collided UCI bits and feedback bits, or a combination thereof. In some examples, the UE may determine to transmit at least a portion of the feedback in the second set of uplink symbols.

A method for wireless communications at a UE is described. The method may include monitoring for one or more semi-persistent scheduling transmissions in accordance with one or more semi-persistent scheduling configurations, generating a set of feedback bits associated with the one or more semi-persistent scheduling transmissions, the set of feedback bits scheduled for transmission to a network entity in a first set of uplink symbols, receiving control signaling that changes an availability of the first set of uplink symbols for transmission of the set of feedback bits, deferring transmission of the set of feedback bits to a second set of uplink symbols based on the receiving of the control signaling, determining whether to transmit at least a portion of the set of feedback bits in the second set of uplink symbols, transmitting at least the portion of the set of feedback bits in the second set of uplink symbols in accordance with the determining, and communicating with the network entity in accordance with the determining.

An apparatus for wireless communications at a UE is described. The apparatus may include at least one processor, and memory coupled (e.g., operatively, communicatively, functionally, electronically, or electrically) with the at least one processor, the memory storing instructions executable by the at least one processor to cause the apparatus or the UE to monitor for one or more semi-persistent scheduling transmissions in accordance with one or more semi-persistent scheduling configurations, generate a set of feedback bits associated with the one or more semi-persistent scheduling transmissions, the set of feedback bits scheduled for transmission to a network entity in a first set of uplink symbols, receive control signaling that changes an availability of the first set of uplink symbols for transmission of the set of feedback bits, defer transmission of the set of feedback bits to a second set of uplink symbols based on the receiving of the control signaling, determine whether to transmit at least a portion of the set of feedback bits in the second set of uplink symbols, transmit at least the portion of the set of feedback bits in the second set of uplink symbols in accordance with the determining, and communicate with the network entity in accordance with the determining.

Another apparatus for wireless communications at a UE is described. The apparatus may include means for monitoring for one or more semi-persistent scheduling transmissions in accordance with one or more semi-persistent scheduling configurations, means for generating a set of feedback bits associated with the one or more semi-persistent scheduling transmissions, the set of feedback bits scheduled for transmission to a network entity in a first set of uplink symbols, means for receiving control signaling that changes an availability of the first set of uplink symbols for transmission of the set of feedback bits, means for deferring transmission of the set of feedback bits to a second set of uplink symbols based on the receiving of the control signaling, means for determining whether to transmit at least a portion of the set of feedback bits in the second set of uplink symbols, means for transmitting at least the portion of the set of feedback bits in the second set of uplink symbols in accordance with the determining, and means for communicating with the network entity in accordance with the determining.

A non-transitory computer-readable medium storing code for wireless communications at a UE is described. The code may include instructions executable by at least one processor to monitor for one or more semi-persistent scheduling transmissions in accordance with one or more semi-persistent scheduling configurations, generate a set of feedback bits associated with the one or more semi-persistent scheduling transmissions, the set of feedback bits scheduled for transmission to a network entity in a first set of uplink symbols, receive control signaling that changes an availability of the first set of uplink symbols for transmission of the set of feedback bits, defer transmission of the set of feedback bits to a second set of uplink symbols based on the receiving of the control signaling, determine whether to transmit at least a portion of the set of feedback bits in the second set of uplink symbols, transmit at least the portion of the set of feedback bits in the second set of uplink symbols in accordance with the determining, and communicate with the network entity in accordance with the determining.

Some examples of the method, apparatuses, and non-transitory computer-readable medium described herein may further include operations, features, means, or instructions for determining that a size of the set of feedback bits may be greater than a size of an allocation in the second set of uplink symbols for transmission of the set of feedback bits, where the determining whether to transmit at least the portion of the set of feedback bits in the second set of uplink symbols may be based on the determining that the size of the set of feedback bits may be greater than the size of the allocation in the second set of uplink symbols.

Some examples of the method, apparatuses, and non-transitory computer-readable medium described herein may further include operations, features, means, or instructions for deferring transmission of the set of feedback bits to a third set of uplink symbols based on the size of the allocation.

Some examples of the method, apparatuses, and non-transitory computer-readable medium described herein may further include operations, features, means, or instructions for transmitting at least the portion of the set of feedback bits in the second set of uplink symbols based on the size of the allocation.

Some examples of the method, apparatuses, and non-transitory computer-readable medium described herein may further include operations, features, means, or instructions for generating a set of uplink control information bits scheduled for transmission to the network entity in the second set of uplink symbols, where the determining whether to transmit at least the portion of the set of feedback bits in the second set of uplink symbols may be based on generating the set of uplink control information bits.

Some examples of the method, apparatuses, and non-transitory computer-readable medium described herein may further include operations, features, means, or instructions for transmitting at least the portion of the set of feedback bits and the set of uplink control information bits in the second set of uplink symbols based on generating the set of uplink control information bits.

Some examples of the method, apparatuses, and non-transitory computer-readable medium described herein may further include operations, features, means, or instructions for determining that a size of the set of feedback bits and the set of uplink control information bits may be greater than a size of an allocation in the second set of uplink symbols for transmission of the set of feedback bits and the set of uplink control information bits and refraining from transmitting at least the portion of the set of feedback bits and the set of uplink control information bits in the second set of uplink symbols based on the determining that the size of the set of feedback bits and the set of uplink control information bits may be greater than the size of the allocation, where the communicating with the network entity includes the refraining.

Some examples of the method, apparatuses, and non-transitory computer-readable medium described herein may further include operations, features, means, or instructions for deferring transmission of the set of feedback bits and the set of uplink control information bits to a third set of uplink symbols based on the size of the allocation.

In some examples of the method, apparatuses, and non-transitory computer-readable medium described herein, the determining whether to transmit at least the portion of the set of feedback bits in the second set of uplink symbols may be based on a type of the set of uplink control information bits.

Some examples of the method, apparatuses, and non-transitory computer-readable medium described herein may further include operations, features, means, or instructions for transmitting the set of uplink control information bits in the second set of uplink symbols and deferring transmission of the set of feedback bits to a third set of uplink symbols based on generating the set of uplink control information bits.

Some examples of the method, apparatuses, and non-transitory computer-readable medium described herein may further include operations, features, means, or instructions for transmitting at least the portion of the set of feedback bits in the second set of uplink symbols in accordance with the determining and deferring transmission of the set of uplink control information bits to a third set of uplink symbols based on transmitting at least the portion of the set of feedback bits in the second set of uplink symbols.

Some examples of the method, apparatuses, and non-transitory computer-readable medium described herein may further include operations, features, means, or instructions for generating a compressed feedback bit based on generating the set of feedback bits, the compressed feedback bit associated with at least the portion of the set of feedback bits and transmitting the compressed feedback bit in the second set of uplink symbols based on generating the set of uplink control information bits.

Some examples of the method, apparatuses, and non-transitory computer-readable medium described herein may further include operations, features, means, or instructions for determining that the second set of uplink symbols occurs a quantity of slots after the first set of uplink symbols and refraining from transmitting at least the portion of the set of feedback bits in the second set of uplink symbols based on the quantity of slots, where the communicating with the network entity includes the refraining.

In some examples of the method, apparatuses, and non-transitory computer-readable medium described herein, each slot of the quantity of slots includes uplink symbols, flexible symbols, or both, and the flexible symbols may be configured for transmission of uplink transmissions or downlink transmissions.

Some examples of the method, apparatuses, and non-transitory computer-readable medium described herein may further include operations, features, means, or instructions for determining an order of the set of feedback bits in a feedback codebook for transmission in the second set of uplink symbols, where determining whether to transmit at least the portion of the set of feedback bits in the second set of uplink symbols is based on the order of the set of feedback bits in the feedback codebook.

Some examples of the method, apparatuses, and non-transitory computer-readable medium described herein may further include operations, features, means, or instructions for determining to transmit at least the portion of the set of feedback bits in the second set of uplink symbols based on the order of the set of feedback bits in the feedback codebook, where the feedback codebook is a first type of feedback codebook or a second type of feedback codebook that includes a concatenation of a set of feedback codebooks associated with the first set of uplink symbols.

In some examples of the method, apparatuses, and non-transitory computer-readable medium described herein, the concatenation of the set of feedback codebooks is based on an order of the set of feedback codebooks in time.

Some examples of the method, apparatuses, and non-transitory computer-readable medium described herein may further include operations, features, means, or instructions for generating a feedback codebook based on a set of indices associated corresponding to a serving cell, the one or semi-persistent scheduling configurations, the first set of uplink symbols, and the second set of uplink symbols, and determining to transmit at least the portion of the set of feedback bits in the second set of uplink symbols in accordance with the generated feedback codebook.

Some examples of the method, apparatuses, and non-transitory computer-readable medium described herein may further include operations, features, means, or instructions for generating a set of uplink control information bits and a feedback codebook scheduled for transmission to the network entity in the second set of uplink symbols, where determining whether to transmit at least the portion of the set of feedback bits in the second set of uplink symbols is based on generating the set of uplink control information bits and the feedback codebook, where the feedback codebook is a first type of feedback codebook or a second type of feedback codebook that includes a concatenation of a set of feedback codebooks associated with the first set of uplink symbols, and transmitting at least the portion of the set of feedback bits and the set of uplink control information bits in the second set of uplink symbols based on generating the set of uplink control information bits and in accordance with the feedback codebook.

Some examples of the method, apparatuses, and non-transitory computer-readable medium described herein may further include operations, features, means, or instructions for deferring transmission of the set of feedback bits to a third set of uplink symbols, where an allocation in the third set of uplink symbols for transmission of the set of feedback bits overlaps with one or more scheduled downlink transmissions, and where an offset between the allocation and the one or more scheduled downlink transmissions satisfies a threshold.

Some examples of the method, apparatuses, and non-transitory computer-readable medium described herein may further include operations, features, means, or instructions for refraining from transmitting at least a portion of the set of feedback bits in the third set of uplink symbols based on the overlapping one or more scheduled downlink transmissions, where communicating with the network entity includes the refraining.

Some examples of the method, apparatuses, and non-transitory computer-readable medium described herein may further include operations, features, means, or instructions for deferring transmission of the set of feedback bits to a third set of uplink symbols, where an allocation in the third set of uplink symbols includes a second set of feedback bits for a DG, and refraining from transmitting at least a portion of the set of feedback bits in the third set of uplink symbols based on the deferring.

Some examples of the method, apparatuses, and non-transitory computer-readable medium described herein may further include operations, features, means, or instructions for deferring transmission of the set of feedback bits to a third set of uplink symbols, where the set of feedback bits are associated with an uplink DG and where an allocation in the third set of uplink symbols includes a second set of feedback bits associated with a downlink DG.

Some examples of the method, apparatuses, and non-transitory computer-readable medium described herein may further include operations, features, means, or instructions for determining that an allocation of a third set of uplink symbols is non-overlapping with a symbols corresponding to a control resource set, and deferring transmission of the set of feedback bits to a third set of uplink symbols based on the determining.

Some examples of the method, apparatuses, and non-transitory computer-readable medium described herein may further include operations, features, means, or instructions for determining that a size of the set of feedback bits is greater than a size of an allocation in the second set of uplink symbols for transmission of the set of feedback bits, where the determining whether to transmit at least the portion of the set of feedback bits in the second set of uplink symbols is based on the determining that the size of the set of feedback bits is greater than the size of the allocation in the second set of uplink symbols.

Some examples of the method, apparatuses, and non-transitory computer-readable medium described herein may further include operations, features, means, or instructions for determining that the second set of uplink symbols occurs a quantity of symbols after the first set of uplink symbols and refraining from transmitting at least the portion of the set of feedback bits in the second set of uplink symbols based on the quantity of symbols, where the communicating with the network entity includes the refraining.

Some examples of the method, apparatuses, and non-transitory computer-readable medium described herein may further include operations, features, means, or instructions for determining a respective priority associated with each feedback bit of the set of feedback bits and transmitting at least the portion of the set of feedback bits in the second set of uplink symbols in accordance with the determining the respective priorities.

In some examples of the method, apparatuses, and non-transitory computer-readable medium described herein, the control signaling indicates that the first set of uplink symbols at least partially overlap with a set of downlink symbols, a set of synchronization signal block symbols, or both.

### BRIEF DESCRIPTION OF THE DRAWINGS

FIG. 1 illustrates an example of a wireless communications system that supports techniques for multiplexing uplink control information in accordance with aspects of the present disclosure.

FIG. 2 illustrates an example of a wireless communications system that supports techniques for multiplexing uplink control information in accordance with aspects of the present disclosure.

FIG. 3 illustrates an example of a transmission scheme that supports techniques for multiplexing uplink control information in accordance with aspects of the present disclosure.

FIG. 4 illustrates an example of a process flow that supports techniques for multiplexing uplink control information in accordance with aspects of the present disclosure.

FIGS. 5 and 6 show block diagrams of devices that support techniques for multiplexing uplink control information in accordance with aspects of the present disclosure.

FIG. 7 shows a block diagram of a communications manager that supports techniques for multiplexing uplink control information in accordance with aspects of the present disclosure.

FIG. 8 shows a diagram of a system including a device that supports techniques for multiplexing uplink control information in accordance with aspects of the present disclosure.

FIGS. 9 and 10 show flowcharts illustrating methods that support techniques for multiplexing uplink control information in accordance with aspects of the present disclosure.

### DETAILED DESCRIPTION

In some wireless communications systems, a user equipment (UE) may be configured to monitor for semi-persistent scheduling (SPS) transmissions from a network entity. The UE may transmit feedback bits (e.g., hybrid automatic repeat request (HARQ) acknowledgment (ACK) or negative ACK (HACK)) associated with the SPS transmissions using a physical uplink control channel (PUCCH) according to an SPS configuration. Although the techniques herein are described in the context of SPS HARQ ACK/NACK bits, it is to be understood that the techniques may also be applicable to transmission of other feedback bits, such as channel state information (CSI) and other uplink control information (UCI).

In some cases, feedback bits may conflict (e.g., collide) with downlink symbols from a network entity. For example, a network entity may transmit control signaling (e.g., radio resource control (RRC) signaling) that indicates resources for transmitting the feedback bits are configured for downlink transmissions, and so are no longer available for uplink transmissions (e.g., feedback). In some cases, the UE may defer the PUCCH to the next slot that may accommodate the PUCCH resource. In some cases, the UE may check a candidate target slot for carrying the deferred PUCCH for multiple collided SPS PUCCH transmissions. The target slot may not accommodate the PUCCH resource carrying the SPS feedback bits from all the collided SPS PUCCH transmissions. In some other cases, the candidate target slot may already carry existing, non-deferred UCI bits for transmission and the candidate target slot may not have the capacity to carry the PUCCH for existing UCI bits plus the SPS feedback bits from the collided SPS PUCCH transmissions. It may be beneficial for the UE to determine whether to skip the candidate target slot and check the availability of a next slot, or transmit the existing UCI bits or part of the collided SPS feedback bits in the candidate target slot.

Techniques are described herein which support a UE multiplexing mixed deferred and non-deferred existing UCI bits in a same slot. A UE may monitor for SPS transmissions from a network entity. Based on the monitoring, the UE may generate SPS feedback bits (e.g., ACK/NACK bits) scheduled for transmission to the network entity in a first set of uplink symbols (e.g., a first slot format). In some cases, a collision may occur during transmission if a PUCCH carrying SPS feedback bits at least partially overlaps with downlink symbols (e.g., RRC configured downlink symbols). Because of the collision, the UE may defer transmission of the feedback bits to a second set of uplink symbols (e.g., a second slot format) to avoid the collision.

In some cases, the second set of uplink symbols may already carry existing, non-deferred UCI bits to be transmitted, and the UE may multiplex the deferred SPS feedback bits and the non-deferred UCI bits in the target slot for transmitting. For example, if a candidate target slot already has existing, non-deferred UCI bits, it may not accommodate the non-deferred UCI bits and the deferred feedback bits (e.g., the size of the feedback bits and UCI bits combined may be greater than an allocation size of the second set of uplink symbols). In some cases, the UE may cancel (e.g., drop) transmission of some or all of the UCI bits or the feedback bits, or may continue to check the next slot for transmitting all collided UCI bits and feedback bits, or a combination thereof. In some examples, the UE may determine to transmit at least a portion of the feedback in the second set of uplink symbols.

Particular aspects of the subject matter described herein may be implemented to realize one or more advantages. The described techniques may support improvements in multiplexing UCI by reducing signaling overhead and power usage. By deferring collided SPS feedback based on different channel conditions, reducing the number of collisions, and prioritizing transmissions based on uplink symbol availability, the UE may utilize available resources more efficiently and improve user experience. As such, supported techniques may include improved network operations and, in some examples, may promote network efficiencies, among other benefits.

Aspects of the disclosure are initially described in the context of wireless communications systems. Aspects of the disclosure are further illustrated by and described with reference to a transmission scheme, a process flow, apparatus diagrams, system diagrams, and flowcharts that relate to techniques for multiplexing uplink control information.

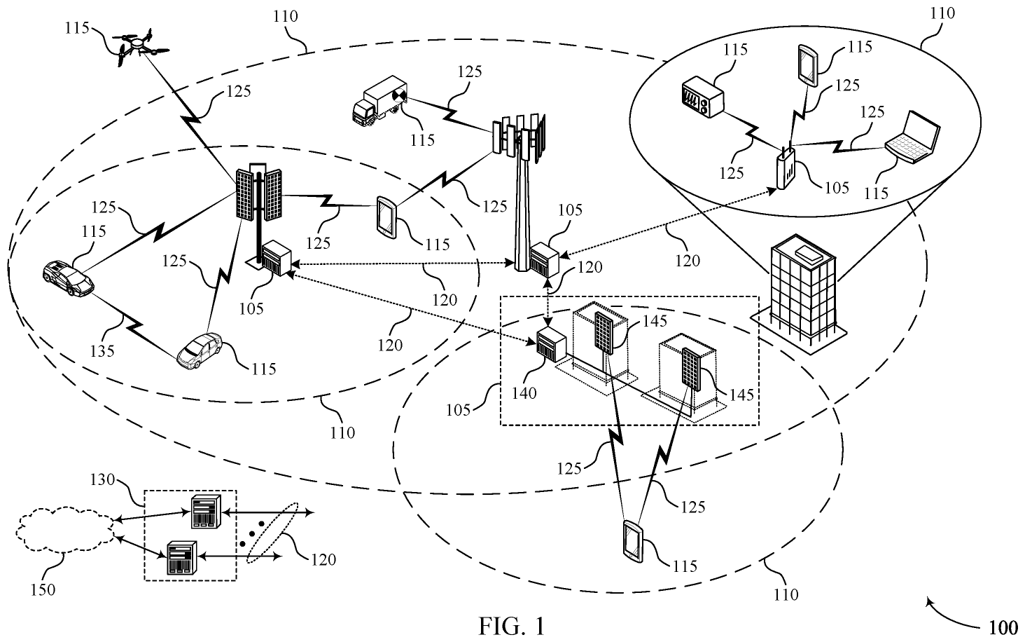

FIG. 1 illustrates an example of a wireless communications system 100 that supports techniques for multiplexing uplink control information in accordance with aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The network entities 105 may be dispersed throughout a geographic area to form the wireless communications system 100 and may be devices in different forms or having different capabilities. The network entities 105 and the UEs 115 may wirelessly communicate via one or more communication links 125. Each network entity 105 may provide a coverage area 110 over which the UEs 115 and the network entity 105 may establish one or more communication links 125. The coverage area 110 may be an example of a geographic area over which a network entity 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the network entities 105, or network equipment (e.g., core network nodes, relay devices, integrated access and backhaul (IAB) nodes, or other network equipment), as shown in FIG. 1. As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link (e.g., in accordance with a midhaul interface protocol) or a fronthaul communication link (e.g., in accordance with a fronthaul interface protocol), or any combination thereof. The backhaul communication links 120, midhaul communication links, or fronthaul communication links may be or include one or more wired links (e.g., an electrical link, an optical fiber link), one or more wireless links (e.g., a radio link, a wireless optical link), among other examples or various combinations thereof.

One or more of the network entities 105 described herein may include or may be referred to as a network entity (e.g., a base transceiver station, a radio network entity, an access point, a radio transceiver, a NodeB, an eNodeB (eNB), a next-generation NodeB or a giga-NodeB (either of which may be referred to as a gNB), a next-generation eNB (ng-eNB), a Home NodeB, a Home eNodeB, or other suitable terminology). A network entity 105 may be implemented in an aggregated or monolithic network entity architecture, or alternatively, in a disaggregated network entity architecture. For example, a network entity 105 may include one or more of a central unit (CU), a distributed unit (DU), a radio unit (RU), a Radio Access Network (RAN) Intelligent Controller (MC) (e.g., a Near-Real Time MC (Near-RT MC), a Non-Real Time RIC (Non-RT RIC), a Service Management and Orchestration (SMO) system, or any combination thereof. An RU may also be referred to as a radio head, a smart radio head, a remote radio head (RRH), a remote radio unit (RRU), or a transmission/reception point (TRP). One or more components of the network entities 105 of a disaggregated RAN may be co-located, or one or more components of the network entities 105 may be located in distributed locations.

The split of functionality between a CU, a DU, and an RU is flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some examples, the CU may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU. Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some cases, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU). A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some examples, a midhaul communication link or a fronthaul communication link may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an integrated access backhaul (IAB) network architecture (e.g., to a core network 130). In some cases, in an IAB network, one or more network entities 105 (e.g., IAB nodes) may be partially controlled by each other. One or more IAB nodes may be referred to as a donor entity or an IAB donor. One or more DUs (e.g., one or more RUs) may be partially controlled by CUs associated with a donor network entity 105 (e.g., a donor network entity). The one or more donor network entities 105 (e.g., IAB donors) may be in communication with one or more additional network entities 105 (e.g., IAB nodes) via supported access and backhaul links (e.g., backhaul communication links 120). IAB nodes may include an IAB mobile termination (IAB-MT) controlled (e.g., scheduled) by DUs of a coupled IAB donor. An IAB-MT may include an independent set of antennas for relay of communications with UEs 115, or may share the same antennas (e.g., of an RU) of an IAB node used for access via the DU of the IAB node (e.g., referred to as virtual IAB-MT (vIAB-MT)). In some examples, the IAB nodes may include DUs that support communication links with additional entities (e.g., IAB nodes, UEs 115) within the relay chain or configuration of the access network (e.g., downstream). In such cases, one or more components of the disaggregated RAN architecture (e.g., one or more IAB nodes or components of IAB nodes) may be configured to operate according to the techniques described herein.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay network entities, among other examples, as shown in FIG. 1.

The UEs 115 and the network entities 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a network entity 105, or downlink transmissions from a network entity 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δ_{ƒ}) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1(Δƒₘₐₓ·Nƒ) seconds, where Δƒₘₐₓ may represent the maximum supported subcarrier spacing, and N_{ƒ} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 may be movable and therefore provide communication coverage for a moving geographic coverage area 110. In some examples, different geographic coverage areas 110 associated with different technologies may overlap, but the different geographic coverage areas 110 may be supported by the same network entity 105. In other examples, the overlapping geographic coverage areas 110 associated with different technologies may be supported by different network entities 105. The wireless communications system 100 may include, for example, a heterogeneous network in which different types of the network entities 105 provide coverage for various geographic coverage areas 110 using the same or different radio access technologies.

The wireless communications system 100 may support synchronous or asynchronous operation. For synchronous operation, the network entities 105 may have similar frame timings, and transmissions from different network entities 105 may be approximately aligned in time. For asynchronous operation, the network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (e.g., Institute of Electrical and Electronics Engineers (IEEE) 802.11) network may include an access point (AP) that may communicate with one or more wireless or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a device may communicate with an associated AP via downlink (e.g., the communication link from the AP to the device) and uplink (e.g., the communication link from the device to the AP). A wireless personal area network (PAN), which may include a Bluetooth connection, may provide for short range wireless connections between two or more paired wireless devices. For example, wireless devices such as cellular phones may utilize wireless PAN communications to exchange information such as audio signals with wireless headsets. Components within a wireless communication system may be coupled (for example, operatively, communicatively, functionally, electronically, and/or electrically) to each other.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a network entity 105. Other UEs 115 in such a group may be outside the geographic coverage area 110 of a network entity 105 or be otherwise unable to receive transmissions from a network entity 105. In some examples, groups of the UEs 115 communicating via D2D communications may utilize a one-to-many (1:M) system in which each UE 115 transmits to every other UE 115 in the group. In some examples, a network entity 105 facilitates the scheduling of resources for D2D communications. In other cases, D2D communications are carried out between the UEs 115 without the involvement of a network entity 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a network entity 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or network entity 105 may be distributed across various network devices (e.g., radio heads and ANCs) or consolidated into a single network device (e.g., a network entity 105).

The wireless communications system 100 may operate using one or more frequency bands, for example in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more network entity antennas or antenna arrays may be co-located at an antenna assembly, such as an antenna tower. In some examples, antennas or antenna arrays associated with a network entity 105 may be located in diverse geographic locations. A network entity 105 may have an antenna array with a number of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beam forming operations. For example, a network entity 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times in different directions. For example, the network entity 105 may transmit a signal according to different beamforming weight sets associated with different directions of transmission. Transmissions in different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a network entity 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the network entity 105 in different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or radio frequency beamforming to generate a combined beam for transmission (e.g., from a network entity 105 to a UE 115). The UE 115 may report feedback that indicates precoding weights for one or more beam directions, and the feedback may correspond to a configured number of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a network entity 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the network entity 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the physical layer, transport channels may be mapped to physical channels.

The UEs 115 and the network entities 105 may support retransmissions of data to increase the likelihood that data is received successfully. HARQ feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, a UE 115 may multiplex mixed deferred and non-deferred existing UCI bits in a same slot. The UE 115 may monitor for SPS transmissions from a network entity 105. Based on the monitoring, the UE 115 may generate SPS feedback bits (e.g., ACK/NACK bits) scheduled for transmission to the network entity 105 in a first set of uplink symbols (e.g., a first slot format). In some cases, a collision may occur during transmission if a PUCCH carrying SPS feedback bits at least partially overlaps with downlink symbols (e.g., RRC configured downlink symbols). Because of the collision, the UE 115 may defer transmission of the feedback bits to a second set of uplink symbols (e.g., a second slot format) to avoid the collision.

In some cases, the second set of uplink symbols may already carry existing, non-deferred UCI bits to be transmitted, and the UE 115 may multiplex the deferred SPS feedback bits and the non-deferred UCI bits in the target slot for transmitting. For example, if a candidate target slot already has existing, non-deferred UCI bits, it may not accommodate the non-deferred UCI bits and the deferred feedback bits (e.g., the size of the feedback bits and UCI bits combined may be greater than an allocation size of the second set of uplink symbols). In some cases, the UE 115 may cancel (e.g., drop) transmission of some or all of the UCI bits or the feedback bits, or may continue to check the next slot for transmitting all collided UCI bits and feedback bits, or a combination thereof. In some examples, the UE 115 may determine to transmit at least a portion of the feedback in the second set of uplink symbols.

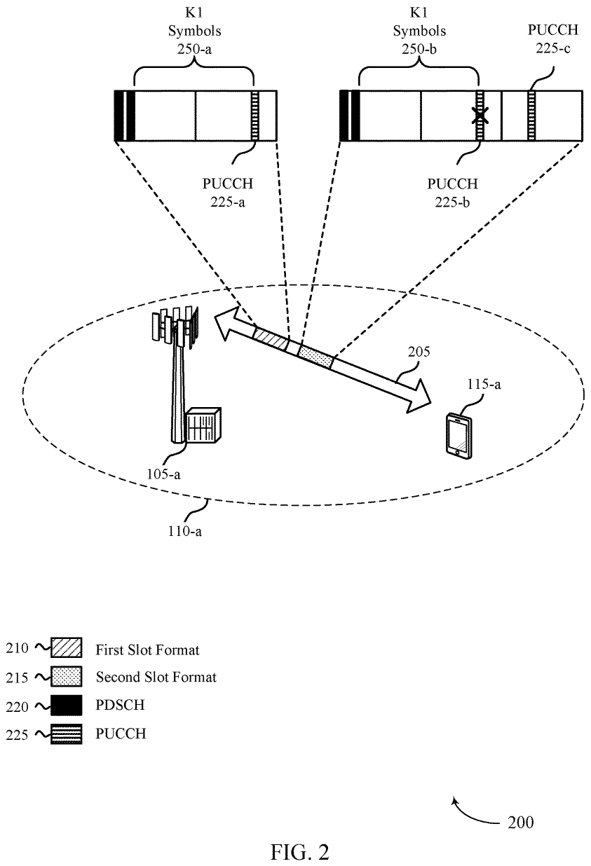

FIG. 2 illustrates an example of a wireless communications system 200 that supports techniques for multiplexing uplink control information in accordance with aspects of the present disclosure. In some examples, the wireless communications system 200 may implement aspects of the wireless communications system 100 or may be implemented by aspects of the wireless communications system 100. For example, the wireless communications system 200 may include a network entity 105-a and a UE 115-a, which may be examples of corresponding devices described herein with reference to FIG. 1.

In some examples, the network entity 105-a and the UE 115-a may communicate via a communication link 205 within a coverage area 110-a of the network entity 105-a. The UE 115-a may monitor for SPS transmissions (e.g., from the network entity 105-a), for example in a PDSCH 220, according to one or more SPS configurations. Based on the monitoring, the UE 115-a may generate SPS feedback bits (e.g., ACK/NACK bits) scheduled for transmission to the network entity 105-a in a first slot format 210. The first slot format 210 may include a duration of K1 symbols 250-a, which may separate a PDSCH 220 and a corresponding PUCCH 225-a.

In some cases, such as in a second slot format 215, a PUCCH 225-b may conflict (e.g., collide) with downlink symbols (e.g., RRC configured downlink symbols) from the network entity 105-a. For example, the network entity 105-a may transmit control signaling (e.g., RRC signaling) that indicates resources for transmitting the PUCCH 225-b are configured for downlink transmissions, and so are no longer available for uplink transmissions. Because of the collision, the UE 115-a may defer SPS ACK/NACK bits scheduled for transmission in the PUCCH 225-b to the earliest slot that may accommodate the SPS ACK/NACK bits. For example, the UE 115-a may check a candidate target slot for carrying a deferred PUCCH 225-c for multiple collided SPS PUCCH transmissions, but the candidate target slot may not accommodate the PUCCH resource carrying SPS ACK/NACK bits from all the collided SPS PUCCH transmissions. The UE 115-a may determine whether to skip that candidate target slot and check the next slot, or transmit part of the collided SPS ACK/NACK bits on that candidate target slot. In some other cases, the candidate target slot may already be carrying existing non-deferred UCI bits for transmission, and as such, the candidate target slot may not have the capacity to carry the PUCCH for existing UCI bits plus the SPS ACK/NACK bits from the collided PUCCH transmissions. It may be beneficial for the UE 115-a to determine whether to skip the candidate target slot and check the availability of a next slot, or transmit the existing UCI bits or part of the collided SPS ACK/NACK bits in the candidate target slot.

In some examples, the UE 115-a may multiplex mixed deferred and non-deferred existing UCI bits in the same slot. After a collision between the PUCCH 225-b and one or more downlink symbols, the UE 115-a may defer transmission of SPS ACK/NACK bits scheduled for transmission in the PUCCH 225-b to avoid the collision. For example, the second slot format 215 may include a duration of K1 symbols 250-b, which may separate a PDSCH 220 and a corresponding PUCCH 225-b. In some cases, the second slot format 215 may already carry existing, non-deferred UCI bits to be transmitted in the PUCCH 225-c, and the UE 115-a may multiplex the mixed deferred SPS ACK/NACK bits and the non-deferred UCI bits in the target slot for transmitting in the PUCCH 225-c. In some examples, if a candidate target slot already has existing, non-deferred UCI bits, it may not accommodate the non-deferred UCI bits and the deferred SPS ACK/NACK bits combined. That is, the size of the set of SPS ACK/NACK bits and UCI bits combined may be greater than an allocation size of uplink symbols in the PUCCH 225-c. In some cases, the UE 115-a may cancel (e.g., drop) some or all of the UCI bits or the SPS ACK/NACK bits in the PUCCH 225-c, or may continue to check a next slot (not shown) for transmitting all collided UCI bits and SPS ACK/NACK bits, or a combination thereof. In some examples, the UE 115-a may then determine to transmit at least a portion of the SPS ACK/NACK bits in the PUCCH 225-c

In some cases, the UE 115-a may defer and transmit at least a portion of the deferred SPS ACK/NACK bits in the PUCCH 225-c based on one or more channel conditions. In some examples, SPS ACK/NACK bits from multiple collided PUCCHs 225 may be deferred to the same new PUCCH 225 (e.g., the deferred PUCCH 225-c). A new codebook in the new PUCCH 225 may be a concatenation of the individual codebooks originally from the collided PUCCHs 225, for example based on the order in time of the PUCCHs 225. For SPS ACK/NACK deferral, the deferred SPS ACK/NACK bits from more than one initial PUCCH slot may be jointly deferred to the target slot. In some cases, when there is no existing, non-deferred UCI bit in a candidate target slot, and if the target slot may not accommodate the PUCCH 225 selected for all collided ACK/NACK bits, the UE 115-a may not transmit any collided ACK/NACK bits in that target slot, and may continue to check the next candidate slot for transmitting all of the collided ACK/NACK bits.

In some cases, in the presence of existing, non-deferred ACK/NACK bits in the target slot, both the collided SPS ACK/NACK bits and the existing ACK/NACK bits may be transmitted in the same PUCCH 225. The new codebook in the PUCCH 225 may be the concatenation of the codebook for the existing ACK/NACK bits and the individual codebooks originally from the collided PUCCH transmissions. In some cases, in the presence of existing, non-deferred ACK/NACK bits for SPS in the target slot, and if the slot may not accommodate the PUCCH 225 selected for both the existing ACK/NACK bits and the collided SPS ACK/NACK bits, the UE 115-a may drop all of the existing ACK/NACK bits and the collided SPS ACK/NACK bits without further deferral. In some examples, the UE 115-a may not transmit any ACK/NACK bits in that target slot, may treat all existing and collided ACK/NACK bits as collided ACK/NACK bits and, may continue to check the next candidate slot for transmitting all collided ACK/NACK bits that have not expired.

In some cases, the UE 115-a may not retransmit the collided SPS ACK/NACK bits after a quantity of slots from the end of the slot where the PUCCH 225 collision occurred. In some examples, the quantity of slots may be configured per SPS configuration. In some cases, the UE 115-a may or may not allow partial deferral of SPS ACK/NACK bits. In some cases, the network entity 105-a may indicate via DCI that only part of the collided SPS ACK/NACK buts in the collided PUCCH may be deferred. In some cases, the UE 115-a may not support the deferral of only part of the SPS ACK/NACK bits in the collided PUCCH 225. In some cases, if the deferred SPS ACK/NACK and dynamic grant (DG) ACK/NACK are in the same target slot, the UE 115-a may multiplex both SPS ACK/NACK and DG ACK/NACK on the same PUCCH 225 indicated by a PUCCH reception indicator (PM). For SPS ACK/NACK deferral, if after the target PUCCH slot determination the deferred SPS ACK/NACK may not be transmitted, the deferred SPS ACK/NACK bits may be dropped.

In some cases, a collision for deferral purposes may occur if the PUCCH 225-b carrying SPS ACK/NACK bits at least partially overlaps with one or more RRC configured downlink symbols or one or more RRC configured flexible symbols that are signal synchronization block (SSB) symbols or CORESET (e.g., a CORESET 0) symbols. If the PUCCH overlaps with an RRC configured flexible symbol other than an SSB symbol or a CORESET (e.g., a CORESET 0) symbol, the PUCCH transmission may follow an existing rule if the RRC configured flexible symbol is further modified by dynamic slot format indication (SFI). In some cases, a UE 115-a may not expect a collided PUCCH 225 for deferral purposes to also carry ACK/NACK bits for a DG. Put another way, if there is a DG PDSCH and an associated DG PUSCH (e.g., DG ACK/NACK bits) in a given slot, the DCI may allocate sufficient resources for new ACK/NACK bits and SPS ACK/NACK bits.

In some cases, the collided SPS ACK/NACK bits may be deferred to a target slot if the corresponding selected PUCCH resource (e.g., the PUCCH 225-c) is contained within RRC configured uplink symbols. In some cases, the collided SPS ACK/NACK bits may be deferred to a target slot if the corresponding selected PUCCH resource (e.g., the PUCCH 225-c) does not overlap with one or more RRC configured downlink symbols or one or more RRC configured flexible symbols that are SSB symbols or CORESET (e.g., a CORESET 0) symbols. For example, for SPS ACK/NACK deferral, for the determination of valid symbols in the initial and target slots, a collision with semi-static downlink symbols, SSBs, and symbols indicated by a parameter for a CORESET (e.g., a CORESET 0) may be regarded as invalid, indicating a lack of symbols for uplink transmission. In some cases, if a collided PUCCH 225 carries ACK/NACK bits for PDSCH 220 configured according to both DG and SPS configurations, the SPS ACK/NACK deferral rule may be applied to both the DG and SPS ACK/NACK bits. In some cases, if the selected PUCCH carrying deferred ACK/NACK bits overlaps with downlink transmissions scheduled by DCI or the DG in a target slot or with a downlink or flexible symbol indicated by DCI format 2_0, the UE 115-a may drop the deferred ACK/NACK bits without further deferral. As such, for SPS ACK/NACK deferral, if after the target slot determination the UE 115-a may fail to transmit the deferred SPS ACK/NACK, the UE 115-a may drop the deferred SPS ACK/NACK bits.

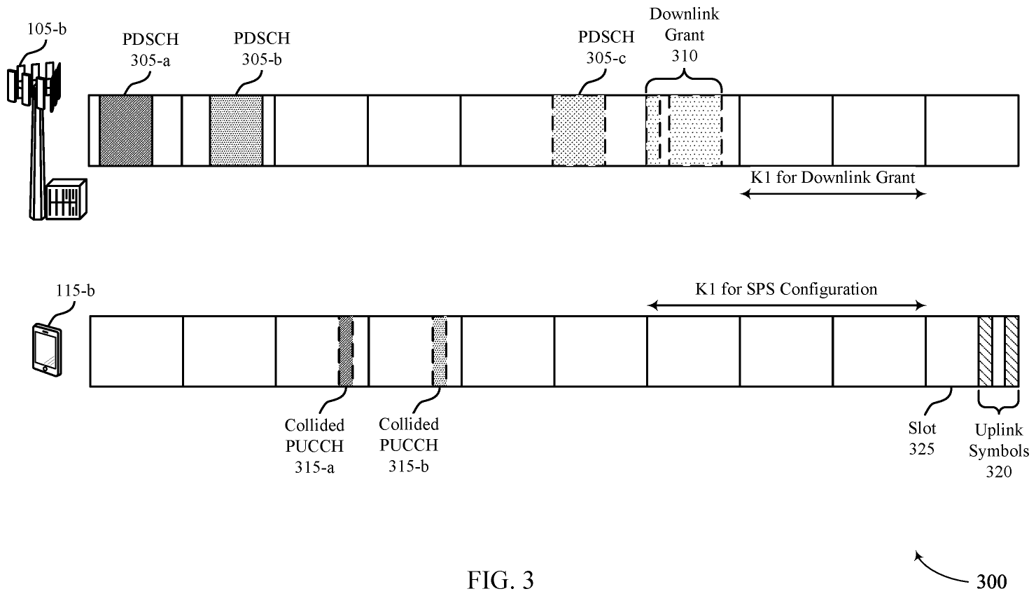

FIG. 3 illustrates an example of a transmission scheme 300 that supports techniques for multiplexing uplink control information in accordance with aspects of the present disclosure. In some examples, the transmission scheme 300 may implement aspects of the wireless communications systems 100 and 200 or may be implemented by aspects of the wireless communications systems 100 and 200. For example, the transmission scheme 300 may illustrate communications between a network entity 105-b and a UE 115-b, which may be examples of corresponding devices described herein with reference to FIGS. 1 and 2. In some cases, a UE 115-b may implement techniques for multiplexing uplink control information to determine how to transmit deferred SPS feedback in a set of uplink symbols in accordance with transmission scheme 300.

In some examples, the network entity 105-b and the UE 115-b may communicate via a communication link (e.g., communication link 205 as described with reference to FIG. 2). The UE 115-b may be configured to monitor for SPS transmissions from the network entity 105-b. For example, the network entity 105-b may transmit an SPS PDSCH 305-a according to a first SPS configuration, which may be referred to as SPS config 1, and a an SPS PDSCH 305-b according to a second SPS configuration, which may be referred to as SPS config 2. In some cases, the UE 115-b may transmit SPS feedback (e.g., SPS ACK/NACK bits) for each SPS PDSCH 305 via a corresponding PUCCH 315. In some cases, the SPS ACK/NACK bits may conflict (e.g., collide) with downlink symbols from the network entity 105-b. For example, the collided SPS ACK/NACK bits may be carried on a collided PUCCH 315-a (e.g., for SPS config 1) or a collided PUCCH 315-b (e.g., for SPS config 2). The network entity 105-b may transmit control signaling (e.g., RRC signaling) that indicates resources for transmitting the PUCCH 315-a and 315-b are configured for downlink transmissions, and so are no longer available for uplink transmissions. In some cases, the UE 115-b may defer the SPS ACK/NACK bits to the earliest slot that may accommodate the PUCCH 315. The UE 115-b may check slot by slot after the slot with the original collided PUCCH 315 until the UE 115-b finds the first slot that may accommodate the same PUCCH resource as the one that collided.

In some cases, the UE 115-b may check a candidate target slot (e.g., the target slot 325) for carrying the deferred PUCCH for multiple collided SPS PUCCH transmissions 315. The target slot 325 may not accommodate the PUCCH 315 carrying SPS ACK/NACK bits from all the collided SPS PUCCH transmissions 315. For example, two SPS PUCCH transmissions, such as the collided PUCCH 315-a and the collided PUCCH 315-b may collide with downlink symbols in corresponding slots, and the UE 115-b may check the target slot 325 (e.g., a mixed uplink and downlink slot) for potential deferred PUCCH to carry the total number of SPS ACK/NACK bits from both collided SPS PUCCHs 315. In some cases, if a PUCCH list (which may be referred to as “SPS-PUCCH-AN-List-r16”) is configured, the UE 115-b may select the PUCCH resource from the list based on the total collided ACK/NACK bits. However, the selected PUCCH resource with a starting symbol and a quantity of symbols or resource blocks (RBs) may not fit into available uplink symbols 320 in the target slot 325. It may be beneficial for the UE 115-b to determine whether to skip the target slot 325 and check the availability of a next slot. In some examples, the network entity 105-b may not guarantee the PUCCH resourced selected based on the total payload including all deferred ACK/NACK bits and potential existing, non-deferred UCI bits may fit into the available uplink symbols 320 of the target slot 325.

In some cases, the target slot 325 may already carry existing, non-deferred UCI bits for transmission, and as such, the target slot 325 may not have the capacity to carry the PUCCH for existing UCI bits plus the SPS ACK/NACK bits from the collided PUCCHs 315. For example, the target slot 325 may be indicated to transmit existing, non-deferred SPS ACK/NACK bits in a third PUCCH (e.g., for an SPS config 3). In some cases, if the PUCCH list SPS-PUCCH-AN-List-r16 is configured, the UE 115-b may select the PUCCH resource from the list based on the total payload of existing and collided ACK/NACK bits. However, the selected PUCCH 315 at a corresponding time and frequency location may not fit into the available uplink symbols 320 in the target slot 325.

In some cases, in addition to transmitting non-deferred ACK/NACK bits for a third SPS PUCCH (e.g., for SPS config 3), the target slot 325 may also be indicated to transmit existing, non-deferred ACK/NACK bits for a downlink DG 310. The UE 115-b may select the PUCCH resource based on a PRI in downlink control information (DCI) of a DG 310 and the total payload of existing ACK/NACK bits and collided SPS ACK/NACK bits. However, the selected PUCCH 315 at a corresponding time and frequency location may not fit into the available uplink symbols 320 in the target slot 325. As such, it may be beneficial to determine whether the UE 115-b may skip the target slot 325 and check the availability of the next slot, or transmit the existing UCI bits or part of the collided SPS ACK/NACK bits in the target slot 325. In some examples, the network entity 105-b may not guarantee the PUCCH resourced selected based on the total payload including all deferred SPS ACK/NACK bits and potential existing, non-deferred UCI bits may fit into the available uplink symbols of a candidate slot (e.g., the uplink symbols 320 of the target slot 325).

In some examples, a UE 115-b may multiplex mixed deferred and non-deferred existing UCI bits in the same slot. The UE 115-b may monitor for one or more SPS transmissions in SPS PDSCHs 305 based on a number of SPS configurations. In some cases, the UE 115-b may generate SPS feedback associated with the SPS transmissions, and may schedule the feedback for transmission to the network entity 105-a in a first set of uplink symbols (e.g., in a PUCCH 315). In some cases, the UE 115-b may receive control signaling from the network entity 105-b that changes the availability of the first slot format for transmitting the feedback. That is, the SPS ACK/NACK bits may conflict (e.g., collide) with downlink symbols from the network entity 105-b. For example, the network entity 105-b may transmit control signaling (e.g., RRC signaling) that indicates resources for transmitting the SPS ACK/NACK bits are configured for downlink transmissions, and so are no longer available for uplink transmissions (e.g., a PUCCH 315). Because of the collision, the UE 115-a may defer transmission of the SPS ACK/NACK bits to a second set of uplink symbols, such as the uplink symbols 320 in the target slot 325 to avoid the collision. In some examples, the UE 115-b may then determine to transmit at least a portion of the SPS ACK/NACK bits in the uplink symbols 320.

In some cases, a collision may occur if a PUCCH 315 carrying SPS ACK/NACK bits partially or fully overlaps with a combination of downlink symbol types, including one or more RRC configured downlink symbols, one or more RRC configured flexible symbols that are SSB symbols or CORESET (e.g., a CORESET 0) symbols, one or more downlink symbols dynamically indicated by DCI (e.g., a DCI format 2_0, which may include a dynamic SFI), one or more downlink transmissions dynamically scheduled by DCI, including at least a CSI reference signal (CSI-RS) and an SPS PDSCH 305, and one or more RRC configured flexible symbols under any combination of one or more conditions. For example, the symbols may include any one or more RRC configured flexible symbols without any condition.

In some cases, the symbols may include any one or more RRC configured flexible symbols when the network entity 105-b may indicate no uplink transmissions on RRC configured flexible symbols at least if the UE 115-b does not receive DCI format 2_0 providing a slot format for these symbols. In some cases, the indication of no uplink transmissions on those symbols may be from the network entity 105-b refraining from configuring an RRC flag (e.g., enableConfiguredUL). In some cases, the symbols may include any one or more RRC configured flexible symbols within a quantity X symbols from the latest RRC or DCI indicated downlink symbols, where X may represent an uplink to downlink switching time. In some cases, X may be indicated by the network entity 105-b (e.g., via RRC signaling, a MAC-CE, or DCI), X may be based on UE capability, or X may be fixed (e.g., X=1 for FR1, X=2 for FR2). In some cases, the any one or more RRC configured flexible symbols may be different than random access channel (RACH) occasion symbols. In some cases, the UE 115-b may partially or fully cancel the SPS ACK/NACK based on an indication (e.g., a cancellation indicator) from the network entity 105-b. For example, the offset between the DCI scheduling downlink transmissions and the PUCCH 315 for SPS ACK/NACK may be no less than a threshold for the UE 115-b to cancel (e.g., drop) the PUCCH. In some cases, the UE 115-b may apply these techniques for SPS ACK/NACK bits and UCI bits with the same uplink physical layer (PHY) priority (e.g., high or low).

In some examples, after a collision has occurred, the UE 115-b may search for a candidate slot for retransmitting the collided SPS ACK/NACK bits. Starting from the next slot after the collision, the UE may determine a candidate slot that may accommodate all or part of the collided SPS ACK/NACK bits, such as the target slot 325, if the corresponding selected PUCCH resource for retransmitting all or part of the collided SPS ACK/NACK bits in the target slot 325 does not overlap with a combination of symbol types in the target slot 325. The symbol types may include one or more RRC configured downlink symbols, one or more RRC configured flexible symbols that are SSB symbols, one or more downlink symbols dynamically indicated by DCI (e.g., a DCI format 2_0, which may include a dynamic SFI), one or more downlink transmissions dynamically scheduled by DCI, including at least a CSI-RS and an SPS PDSCH 305, and one or more RRC configured flexible symbols under any combination of one or more conditions. For example, the symbols may include any one or more RRC configured flexible symbols without any condition. In some examples, the UE 115-b may determine the target slot 325 based on a total ACK/NACK payload size including deferred ACK/NACK information and non-deferred ACK/NACK information, if any, of the target slot 325.

In some cases, the symbols may include any one or more RRC configured flexible symbols when the network entity 105-b may indicate no uplink transmissions on RRC configured flexible symbols at least if the UE 115-b does not receive DCI format 2_0 providing a slot format for these symbols. In some cases, the indication of no uplink transmissions on those symbols may be from the network entity 105-b refraining from configuring an RRC flag (e.g., enableConfiguredUL). In some cases, the symbols may include any one or more RRC configured flexible symbols within a quantity X symbols from the latest RRC or DCI indicated downlink symbols, where X may represent an uplink to downlink switching time. In some cases, X may be indicated by the network entity 105-b (e.g., via RRC signaling, a MAC-CE, or DCI), X may be based on UE capability, or X may be fixed (e.g., X=1 for FR1, X=2 for FR2). In some cases, the any one or more RRC configured flexible symbols may be different than random access channel (RACH) occasion symbols. In some cases, the target slot 325 may contain up to 14 uplink symbols 320. In some cases, the UE 115-b may apply these techniques for SPS ACK/NACK bits and UCI bits with the same uplink PHY priority (e.g., high or low).

In some cases, a target slot 325 may not accommodate the PUCCH 315 selected for all collided SPS ACK/NACK bits. For example, the target slot 325 may include a limited quantity of uplink symbols 320. The UE 115-b may multiplex mixed deferred and existing UCI bits using one of several options when the PUCCH list SPS-PUCCH-AN-List-r16 is configured. In some cases, the UE 115-b may not transmit any collided SPS ACK/NACK bits in the target slot 325, and may continue to check the next slot for transmitting all collided SPS ACK/NACK bits. In some cases, if the target slot 325 can accommodate the PUCCH 315 selected for a first quantity (e.g., a quantity X) of collided SPS ACK/NACK bits, the UE 115-b may transmit those collided bits. For example, the UE 115-b may search the maximum X starting from X=1, in some cases increasing the X, and continue to check the next slot for transmitting remaining collided SPS ACK/NACK bits.

In another example, the UE 115-b may search the maximum X starting from X equals the total number of collided bits, in some cases decreasing the X, and the UE 115-b may continue to check the next slot for transmitting the remaining collided SPS ACK/NACK bits. In some cases, if the target slot 325 may accommodate the PUCCH 315 selected for the collided SPS ACK/NACK bits X number of collided SPS ACK/NACK PUCCHs 315 among all collided SPS ACK/NACK PUCCHs 315, the UE 115-b may transmit those collided bits using the target slot 325. For example, the UE 115-b may search a set of X PUCCHs 315 maximizing the total PUCCH payload, and the UE 115-b may continue to check the next slot for transmitting the remaining collided SPS ACK/NACK bits. In some cases, the UE 115-b may search the X PUCCHs 315 by increasing from the first X=1 collided PUCCH 315 until the X that maximizes the payload. In some cases, the UE 115-b may search the X PUCCHs 315 by decreasing from X=the total number of collided PUCCHs 315 until the X that maximizes the payload. In some cases, the UE 115-b may apply these techniques for ACK/NACK bits and UCI bits with the same uplink PHY priority (e.g., high or low).

In some examples, a target slot 325 may already have existing, non-deferred UCI bits to be transmitted, such as ACK/NACK bits for an SPS PDSCH 305-c (e.g., for SPS config 3) and the DG 310, which may include a physical downlink control channel (PDCCH) and a physical downlink shared channel (PDSCH). If a target slot 325 may not accommodate the PUCCH 315 selected for all existing UCI bits plus the collided SPS ACK/NACK bits, the UE 115-b may multiplex the mixed bits according to several options. In some cases, the UE 115-b may not transmit any existing UCI bits or collided SPS ACK/NACK bits in the target slot 325. The UE 115-b may treat all existing UCI bits and collided SPS ACK/NACK bits as collided UCI bits, and as such may continue to check the next slot for transmitting all collided UCI bits. Additionally, or alternatively, the UE 115-b may treat the original collided SPS ACK/NACK bits as collided SPS ACK/NACK bits and drop the existing UCI bits. As such, the UE 115-b may continue to check the next slot for transmitting all collided SPS ACK/NACK bits. In some cases, the UE 115-b may treat the original collided SPS ACK/NACK bits plus the existing ACK/NACK bits (e.g., associated with the SPS PDSCH 305-c) as collided SPS ACK/NACK bits, while other existing UCI bits may be dropped. The UE 115-b may continue to check the next slot for transmitting all collided SPS ACK/NACK bits. In some cases, the UE 115-b may drop all existing UCI bits and collided SPS ACK/NACK bits if the corresponding selected PUCCH resource may not fit into the target slot 325 with the existing UCI bits also present. As such, if there is a quantity of ACK/NACK bits for inclusion in the target slot 325 and the allocation of new PUCCH resources is not for the transmission of new and deferred SPS ACK/NACK bits, the UE 115-a may drop both the new and deferred SPS ACK/NACK bits.

In some cases, when searching for the target slot to retransmit the collided SPS ACK/NACK bits, the UE 115-b may skip the target slot 325 with existing, non-deferred UCI bits to be transmitted in the target slot 325. The UE 115-b may transmit existing UCI bits in the target slot 325 based on existing rules, and may continue to check a next slot for transmitting all or part of the collided SPS ACK/NACK bits. In some cases, the UE 115-b may determine separate PUCCH resources for the collided SPS ACK/NACK bits and the existing UCI bits in that target slot 325. For example, the UE 115-b may select a first PUCCH resource based on the payload of all or part of the collided SPS ACK/NACK bits, and may select a second PUCCH resource based on the total payload of existing UCI bits. In some cases, if both PUCCH resources overlap in time or frequency, one of the two PUCCH resources may be transmitted based on a priority option (e.g., at least when the two PUCCH transmissions have the same uplink PHY priority). In some examples, the UE 115-b may transmit the PUCCH 315 carrying the existing UCI bits or the collided SPS ACK/NACK bits. In some examples, the UE 115-b may transmit the PUCCH 315 based on the UCI type. For example, the UE 115-b may first transmit the ACK/NACK, then scheduling requests (SRs), then high priority CSI, and then low priority CSI. In some examples, the UE 115-b may transmit the PUCCH 315 based on the PUCCH location. For example, the UE 115-b may transmit the PUCCH 315 based on the PUCCH 315 arriving earlier or later in time.

In some examples, the UE 115-b may transmit the existing UCI bits plus a portion of the collided SPS ACK/NACK bits in the target slot 325. In some cases, the UE 115-b may determine the PUCCH resource based on the total payload of the existing UCI bits. In addition to the existing UCI bits, the remaining bits that the PUCCH resource may accommodate may be used to carry as many collided SPS ACK/NACK bits as possible. For example, a PUCCH format 0 and format 1 may carry a maximum of 2 bits, while a PUCCH format 2, 3, and 4 may carry a maximum of 1706 bits. In some cases, the UE 115-b may determine the PUCCH resource based on the total payload of existing UCI bits plus a quantity (e.g., X) of compressed bits based on all the collided SPS ACK/NACK bits. For example, the PUCCH resource may be determined if X=1 and the one compressed bit is equal to a logic “AND” operation for all the collided SPS ACK/NACK bits (e.g., the compressed bit is 0 for NACK if any collided ACK/NACK bit is 0 for NACK).

In some cases, the UE 115-b may determine the PUCCH resource based on the total payload of existing UCI bits plus the first X collided SPS ACK/NACK bits. For example, the UE 115-b may search the maximum X starting from X=1 and in some cases increasing the X, and may continue to check the next slot for transmitting remaining collided SPS ACK/NACK bits. In another example, the UE 115-b may search the maximum X starting from X=the total number of collided bits and in some cases decreasing the X, and the UE 115-b may continue to check the next slot for transmitting the remaining collided SPS ACK/NACK bits. In some cases, the UE 115-b may determine the PUCCH resource based on the total payload of the existing UCI bits plus the SPS ACK/NACK bits in X collided PUCCHs 315. The UE 115-b may search the set of X PUCCHs 315 maximizing the total PUCCH payload, and the UE 115-b may continue to check the next slot for transmitting the remaining collided SPS ACK/NACK bits. In some cases, the UE 115-b may search the X PUCCHs 315 by increasing from the first X=1 collided PUCCH 315 until the X that maximizes the payload. In some cases, the UE 115-b may search the X PUCCHs 315 by decreasing from X=the total number of collided PUCCHs 315 until the X that maximizes the payload. In some cases, the UE 115-b may apply these techniques for SPS ACK/NACK bits and UCI bits with the same uplink PHY priority (e.g., high or low). As such, for SPS ACK/NACK deferral, the UE 115-a may determine the target slot 325 as the next PUCCH slot where a PUCCH resource is regarded as valid, or a PUCCH resource (e.g., from PUCCH-ResourceSet) is dynamically indicated. The UE 115-b may determine the target slot 325 based on a total ACK/NACK payload size including deferred SPS ACK/NACK information and non-deferred ACK/NACK information (e.g., if any) of the target slot 325.

In some examples, the UE 115-b may defer the collided SPS ACK/NACK bits or PUCCH 315 for a maximum duration. In some cases, the UE 115-b may not further defer the collided SPS ACK/NACK bits or all the ACK/NACK buts in the same HARQ ACK transmission containing that collided bit after a duration from the end of the slot where the collision occurred for PUCCH containing the collided SPS ACK/NACK bits. The duration may be a quantity (e.g., X) of slots or symbols, and may be configured per SPS configuration. In some cases, the UE 115-b may not retransmit the collided SPS ACK/NACK bits after X slots with one or more uplink or flexible symbols per slot from the end of the slot where the SPS ACK/NACK PUCCH collision occurred. In some cases, the UE 115-b may not retransmit the collided bit after X uplink or flexible symbols from the end of the slot where the SPS ACK/NACK PUCCH collision occurred. As such, for SPS ACK/NACK deferral, a limit on a maximum deferral of SPS ACK/NACK may be defined. In some cases, the X uplink and flexible symbols may be pre-configured or may be indicated by the network entity 105-b (e.g., via DCI, MAC control element (MAC-CE), or RRC signaling), and may be common or different for SPS ACK/NACK bits in different collided PUCCH transmissions 315, which may have the same or different uplink PHY priorities. In some cases, the uplink and flexible symbols may also be RRC configured and may be dynamically indicated by DCI format 2_0 (e.g., in a dynamic SFI). In some cases, the UE 115-b may apply these techniques for SPS ACK/NACK bits and UCI bits with the same uplink PHY priority (e.g., high or low).

In some cases, the target slot 325 may not accommodate the PUCCH 315 selected for all the collided SPS ACK/NACK bits, which also may have different uplink PHY priorities. In some cases, at least when the PUCCH list SPS-PUCCH-AN-List-r16 is configured, the UE 115-b may not transmit any collided SPS ACK/NACK bits in the target slot 325, and may continue to check the next slot for transmitting all collided SPS ACK/NACK bits. In some cases, the UE 115-b may transmit as many high priority collided SPS ACK/NACK bits as possible in the target slot 325. In some examples, the UE 115-b may not transmit low priority collided SPS ACK/NACK bits in the target slot 325. The loading may be in the order of the collided PUCCHs 315 or the collided ACK/NACK bits, and the UE 115-b may check the next slot to transmit the remaining high priority and all of the low priority collided ACK/NACK bits. In some cases, the UE 115-b may transmit as many high priority collided ACK/NACK bits as possible. If the slot may accommodate more bits, then the UE 115-b may transmit as many low priority collided ACK/NACK bits as possible. The low priority SPS ACK/NACK bits may be compressed into fewer bits (e.g., one compressed bit may be equal to a logic “AND” operation for all low priority SPS ACK/NACK bits).

In some examples, the target slot 325 may already have existing, non-deferred UCI bits to be transmitted, and the target slot 325 may not accommodate the PUCCH 315 selected for all existing UCI bits plus the collided SPS ACK/NACK bits, which may also have different uplink PHY priorities. In some cases, the UE 115-b may not transmit any existing UCI bits or collided SPS ACK/NACK bits in the target slot 325, and the UE 115-b may continue to check the next slot for transmitting all existing UCI bits and collided SPS ACK/NACK bits. In some cases, the UE 115-b may transmit as many high priority existing UCI bits and collided SPS ACK/NACK bits as possible in the target slot 325. In some examples, the UE 115-b may not transmit any low priority collided SPS ACK/NACK bits in the target slot 325. The loading may be in the order of existing UCI bits then collided PUCCHs, or existing UCI bits and then collided SPS ACK/NACK bits, or first the collided SPS ACK/NACK bits and then the existing UCI bits. The UE 115-b may check the next slot for transmitting the remaining high priority and all of the low priority bits. In some cases, the UE 115-b may transmit as many high priority collided ACK/NACK bits as possible. If the target slot 325 can accommodate more bits, the UE 115-b may transmit as many low priority collided SPS ACK/NACK bits as possible. In some cases, the low priority ACK/NACK bits may be compressed into fewer bits.

In some cases, SPS ACK/NACK bits originally carried in multiple collided PUCCHs 315 may be retransmitted in the same new PUCCH 315, the order of the collided SPS ACK/NACK bits in an ACK/NACK codebook carried by the new PUCCH. In some examples, the SPS ACK/NACK bits from multiple collided PUCCHs 315 may not be retransmitted in the same new PUCCH 315. For example, ACK/NACK bits from a single collided PUCCH 315 may be retransmitted in a new PUCCH (e.g., the ACK/NACK bits form the earliest or latest collided PUCCH 315). In some cases, the SPS ACK/NACK bits from multiple collided PUCCHs 315 may be retransmitted in the same new PUCCH 315. In some cases, the codebook may be a concatenation of the individual codebooks originally associated with the collided PUCCHs 315. The concatenation may be based on the order of the collided PUCCHs 315 (e.g., in time). For example, a new codebook may be formed as the codebook from the first earliest collided PUCCH 315, followed by the codebook from the second earliest collided PUCCH 315, followed by the codebook from the third earliest collided PUCCH 315, and so on until the last collided PUCCH 315. In some cases, this technique may be applied to a different codebook types (e.g., a Type 1 codebook or a Type 2 codebook).

In some examples, the new codebook may be constructed based on a similar rule for existing Type 1 codebook construction. In some cases, the one or more bit locations in the new codebook from the SPS ACK/NACK bits from a collided PUCCH 315 may be determined by the time distance (e.g., a K1 value) between the SPS PDSCH 305 associated with the collided PUCCH 315 and the new PUCCH 315. This may imply that the collided SPS ACK/NACK bits for an SPS PDSCH 305 may not be included in the new codebook if the K1 of that SPS occasion to the new PUCCH 315 is not in the configured K1 set. In some cases, for a Type 2 codebook, the new codebook may be the concatenation of a transport block (TB) based sub-codebook and a code block group (CBG) based sub-codebook. For example, the new codebook may be the concatenation of individual TBs or CBG sub-codebooks originally from those collided PUCCHs 315, respectively. As such, for SPS ACK/NACK deferral, deferred SPS ACK/NACK bits from more than one initial PUCCH slot may be jointly deferred to the target slot 325. In some cases, the deferred SPS ACK/NACK bits may be appended to the initial HARQ bits or codebook (e.g., Type 1 or Type 2) in the target slot 325.

In some cases, the new PUCCH 315 may only carry SPS ACK/NACK bits, and the new codebook carried in the new PUCCH 315 may be constructed in a provided order. In some cases, the UE 115-b may first check each component carrier (CC) in an ordered CC identifier (ID) list (e.g., from lowest to highest configured CC ID). For a given CC ID, the UE 115-b may check each SPS configuration ID in an ordered SPS configuration ID list (e.g., from lowest to highest configured SPS configuration ID). For a given SPS configuration ID, the UE 115-b may check if there exists at least one SPS PDSCH 305 with a corresponding PUCCH 315 carrying corresponding SPS ACK/NACK bits that has a collision with SPS ACK/NACK bits, and has a corresponding maximum deferral deadline that is not yet reached. If this case exists, the UE 115-b may add the SPS ACK/NACK bits to each such SPS PDSCH 305 to the new codebook based on the time order of the at least one such SPS PDSCH 305 (e.g., the SPS ACK/NACK bits for the SPS PDSCH 305 in the earliest downlink slot may be added first). In some cases, to generate the new codebook, the UE 115-b may first loop over all such SPS PDSCHs 305 with PUCCHs 315 that had a collision for a given SPS configuration ID, and then may loop over all SPS configuration IDs in a given CC ID, and then may loop over all CC IDs.

In some cases, SPS ACK/NACK bits originally carried in at least one collided PUCCH 315 as well as existing, non-deferred UCI bits may be retransmitted in the same new PUCCH 315, the order of the collided SPS ACK/NACK bits and the existing UCI bits in an ACK/NACK codebook carried by the new PUCCH 315. In some cases, the SPS ACK/NACK bits from one or more collided PUCCHs 315 and existing UCI bits may not be transmitted in the same PUCCH. As such, SPS ACK/NACK bits from one or more collided PUCCHs 315 or existing UCI bits may be transmitted in the new PUCCH 315. For example, a rule may select either collided SPS ACK/NACK bits or existing UCI bits for that PUCCH 315. In some cases, the existing UCI bits may only be restricted to one or more UCI types, which may include any combination of ACK/NACK bits, CSI reports, and SRs. In some cases, SPS ACK/NACK bits from one or more collided PUCCHs 315 and some types of existing UCI bits may be transmitted in the same PUCCH 315. In some cases, the PUCCH 315 may carry a Type 1 ACK/NACK codebook, where the codebook may be the concatenation of codebooks from existing ACK/NACK bits and one or more individual codebooks originally carried in the one or more collided PUCCHs 315. The concatenation order may be based on a rule. For example, the codebooks from collided PUCCHs 315 may be appended to the codebook from the existing ACK/NACK bits, or the codebook from the existing ACK/NACK bits may be appended to the codebooks from the collided PUCCHs 315.

In some examples, the codebook may be constructed based on a similar rule for existing Type 1 codebook construction. In some cases, the one or more bit locations in the new codebook for the SPS ACK/NACK bits from a collided PUCCH 315 may be determined by the time distance (e.g., a K1 value) between the SPS PDSCH 305 associated with that collided PUCCH 315 and the new PUCCH 315. In some cases, the bit location in the new codebook for each existing ACK/NACK bit may be determined by the K1 between the SPS PDSCH 305 associated with that existing ACK/NACK bit and the new PUCCH 315. In some cases, the codebook may be a concatenation of the individual codebooks originally associated with the collided PUCCHs 315. The concatenation may be based on the order of the collided PUCCHs 315 (e.g., in time). For example, a new codebook may be formed as the codebook from the first earliest collided PUCCH 315, followed by the codebook from the second earliest collided PUCCH 315, followed by the codebook from the third earliest collided PUCCH 315, and so on until the last collided PUCCH 315. In some cases, this technique may be applied to different codebook types (e.g., Type 1 codebook, Type 2 codebook). In some cases, for a Type 2 codebook, the new codebook may be the concatenation of a TB based sub-codebook and a CBG based sub-codebook. For example, the new codebook may be the concatenation of individual TBs or CBG sub-codebooks originally from both existing ACK/NACK bits and the collided PUCCHs 315, whose concatenation order may be determined by a rule. In some cases, the deferred SPS ACK/NACK bits may be appended to the initial HARQ bits or codebook (e.g., Type 1 or Type 2) in the target slot 325.

In some cases, the new PUCCH 315 may only carry SPS ACK/NACK bits, and the new codebook carried in the new PUCCH 315 may be constructed in a provided order. In some cases, the UE 115-b may first check each component carrier (CC) in an ordered CC ID list (e.g., from lowest to highest configured CC ID). For a given CC ID, the UE 115-b may check each SPS configuration ID in an ordered SPS configuration ID list (e.g., from lowest to highest configured SPS configuration ID). For a given SPS configuration ID, the UE 115-b may check if there exists at least one SPS PDSCH 305 with a corresponding PUCCH 315 carrying corresponding SPS ACK/NACK bits that has a collision with SPS ACK/NACK bits, and has a corresponding maximum deferral deadline that is not yet reach. If this case exists, the UE 115-b may add the SPS ACK/NACK bits to each such SPS PDSCH 305 to the new codebook based on the time order of the at least one such SPS PDSCH 305 (e.g., the SPS ACK/NACK bits for the SPS PDSCH 305 in the earliest downlink slot may be added first). In some cases, to generate the new codebook, the UE 115-b may first loop over all such SPS PDSCHs 305 with PUCCHs 315 that had a collision for a given SPS configuration ID, and then may loop over all SPS configuration IDs in a given CC ID, and then may loop over all CC IDs. In some cases, the deferred SPS ACK/NACK bits may be appended to the initial HARQ bits or codebook (e.g., Type 1 or Type 2) in the target slot 325. As such, for SPS ACK/NACK deferral, the bit ordering of the deferred SPS ACK/NACK information from one or more initial slots in the target slot 325 is based on an SPS ACK/NACK bit order principle (e.g., based on a serving cell index, an SPS configuration index, an SPS PDSCH slot index).

In some cases, the collided SPS ACK/NACK bits may be deferred to the target slot 325, where the corresponding selected PUCCH resource does not overlap with one or more RRC configured downlink symbols or RRC configured flexible symbols that are SSB symbols. However, the selected PUCCH resource may overlap with downlink transmissions dynamically scheduled by DCI, including at least CSI-RS and PDSCH, where the offset between the DCI scheduling downlink transmissions and PUCCH for SPS ACK/NACK may be no less than the processing time threshold for the UE 115-b to cancel (e.g., drop) the PUCCH 315. In some cases, the UE 115-b may drop the deferred SPS ACK/NACK bits in the target slot 325, and may receive dynamically scheduled downlink transmissions. In some cases, the dropping may be permanent without further retransmissions or deferral, or the dropped SPS ACK/NACK bits may be further deferred to a later slot with sufficient resources. In some cases, the UE 115-b may transmit the deferred SPS ACK/NACK bits in the target slot 325, and may not receive dynamically scheduled downlink transmissions. For example, for SPS ACK/NACK deferral, if after the target slot 325 determination of the deferred SPS ACK/NACK may not be transmitted, the UE 115-b may drop the deferred SPS ACK/NACK bits.

In some examples, if a collided PUCCH 315 carries ACK/NACK bits for a DCI scheduled downlink DG 310 in addition to SPS ACK/NACK bits for an SPS PDSCH 305, the UE 115-b may clarify whether any SPS ACK/NACK deferral rules described herein may be applied. In some cases, SPS ACK/NACK deferral rules may not apply to collided PUCCHs 315 with both DG 310 and SPS ACK/NACK bits. The UE 115-b may drop all ACK/NACK bits in the collided PUCCH 315 without any deferred transmissions. In some cases, an SPS ACK/NACK deferral rule may be applied to all ACK/NACK bits in collided PUCCHs 315 with both DG 310 and SPS ACK/NACK bits. The UE 115-b may attempt deferred transmissions for all SPS ACK/NACK bits in the collided PUCCHs 315. In some cases, where a new codebook may be constructed by concatenating individual codebooks from collided PUCCHs 315, SPS ACK/NACK bits from one or more collided PUCCHs 315 and some types of existing UCI bits may be transmitted in the same PUCCH 315. In some cases, the PUCCH 315 may carry a Type 1 ACK/NACK codebook, where the codebook may be the concatenation of codebooks from existing ACK/NACK bits and one or more individual codebooks originally carried in the one or more collided PUCCHs 315. The concatenation order may be based on a rule. For example, the codebooks from collided PUCCHs 315 may be appended to the codebook from the existing ACK/NACK bits, or the codebook from the existing ACK/NACK bits may be appended to the codebooks from the collided PUCCHs 315. In some cases, an SPS ACK/NACK deferral rule may be applied to only SPS ACK/NACK bits in the collided PUCCHs 315 with both DG 310 and SPS ACK/NACK bits. The UE 115-b may attempt to defer transmissions for only SPS ACK/NACK bits in the collided PUCCHs 315 with the same codebook construction as described above.

In some cases, the UE 115-b may be configured to construct multiple HARQ ACK/NACK codebooks and the SPS ACK/NACK deferral rules as described herein may be applied to deferred transmissions of collided SPS ACK/NACK bits associated with the same codebook. That is, collided SPS ACK/NACK bits belonging to the same codebook may be sent together in a same deferred transmission, and the deferred transmissions may be determined independently for collided ACK/NACK bits belonging to differ codebooks based on the deferral rule. In some cases, each individual codebook may be identified by any combination of several factors configured by the network entity 105-b. In some cases, the codebook may be associated with an uplink PHY priority as high or low (e.g., with a corresponding priority ID of 0 or 1, respectively). In some cases, the codebook may be associated with a TRP ID in case of multi-TRP operation, where a corresponding TRP ID (e.g., CORESETPoolIndex) may be 0 or 1. In some cases, the codebook may be associated with a PDSCH group index in the case of group-based HARQ-ACK retransmissions (e.g., for a Type 2 codebook), where the PDSCH group indicator may be a 0 or 1. For example, the codebook may have a high uplink PHY priority, a TRP ID of 0, and a PDSCH group index of 0. In some cases, the codebook may also include sub-codebooks, which may be multiplexed into the same codebook (e.g., sub-codebooks with a PDSCH group index of 0 and 1 may be multiplexed in the same codebook).

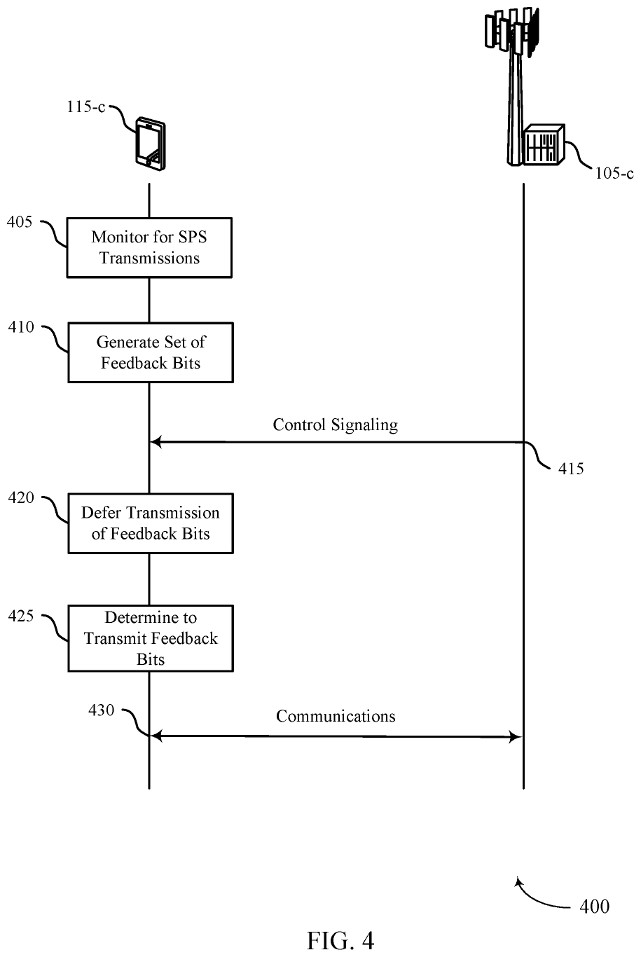

FIG. 4 illustrates an example of a process flow 400 that supports techniques for multiplexing uplink control information in accordance with aspects of the present disclosure. The process flow 400 may implement aspects of wireless communications systems 100 and 200, or may be implemented by aspects of the wireless communications system 100 and 200. For example, the network entity 105-c and the UE 115-c may be examples of a network entity 105 and a UE 115, as described with reference to FIGS. 1 and 2. In the following description of the process flow 400, the operations between the network entity 105-c and the UE 115-c may be transmitted in a different order than the example order shown, or the operations performed by the network entity 105-c and the UE 115-c may be performed in different orders or at different times. Some operations may also be omitted from the process flow 400, and other operations may be added to the process flow 400.

At 405, the UE 115-c may monitor for one or more SPS transmissions according to one or more SPS configurations. For example, the network entity 105-c may transmit a first PDSCH according to a first SPS configuration and a PDSCH according to a second SPS configuration.

At 410, the UE 115-c may generate a set of feedback bits associated with the SPS transmissions, the set of feedback bits scheduled for transmission to a network entity 105-c in a first set of uplink symbols. For example, each feedback bit may indicate whether the UE 115-c successfully received a respective SPS transmission based on the monitoring. In some examples, the feedback bits may include ACK/NACK bits or other feedback bits.

At 415, the UE 115-c may receive control signaling from the network entity 105-c that changes an availability of the first set of uplink symbols for transmission of the set of feedback bits. For example, the network entity 105-c may transmit control signaling (e.g., RRC signaling) that indicates resources for transmitting the feedback bits are configured for downlink transmissions, and so are no longer available for uplink transmissions. Accordingly, the UE 115-c may determine a collision with the configured downlink symbols.

At 420, the UE 115-c may defer transmitting the set of feedback bits to a second set of uplink symbols based on the receiving of the control signaling. For example, based on the collision, the UE 115-c may defer SPS ACK/NACK bits to another slot that may accommodate the SPS ACK/NACK bits.

At 425, the UE 115-c may determine whether to transmit at least a portion of the set of feedback bits in the second set of uplink symbols. At 430, the UE 115-c may communicate with the network entity 105-c in accordance with the determining. For example, the UE 115-c may transmit at least the portion of the set of feedback bits in the second set of uplink symbols. The operations performed at the UE 115-c and the network entity 105-c may improve resource utilization and, in some examples, may promote network efficiency, among other benefits.

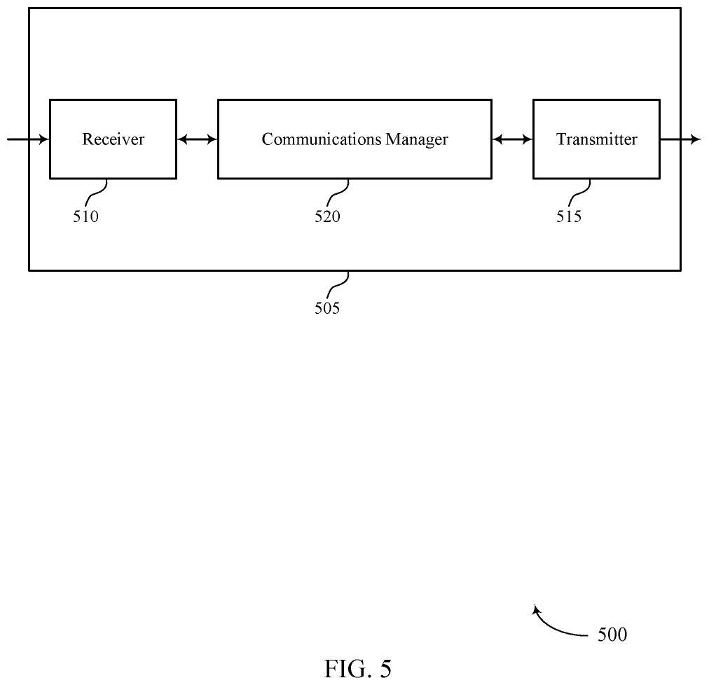

FIG. 5 shows a block diagram 500 of a device 505 that supports techniques for multiplexing uplink control information in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for multiplexing uplink control information). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for multiplexing uplink control information). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of techniques for multiplexing uplink control information as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, at least one processor and memory coupled with the at least one processor may be configured to perform one or more of the functions described herein (e.g., by executing, by the at least one processor, instructions stored in the memory). Additionally, or alternatively, in some examples, the communications manager 520, the receiver 510, the transmitter 515, or various combinations or components thereof may be implemented in code (e.g., as communications management software) executed by a processor. If implemented in code executed by a processor, the functions of the communications manager 520, the receiver 510, the transmitter 515, or various combinations or components thereof may be performed by a general-purpose processor, a DSP, a central processing unit (CPU), a graphics processing unit (GPU), an ASIC, an FPGA, or any combination of these or other programmable logic devices (e.g., configured as or otherwise supporting a means for performing the functions described in the present disclosure).

The processor may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof).

The various illustrative blocks and components described in connection with the disclosure herein may be implemented or performed with a general-purpose processor, a DSP, an ASIC, a CPU, a GPU, an FPGA or other programmable logic device, discrete gate or transistor logic, discrete hardware components, or any combination thereof designed to perform the functions described herein.

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communications at a UE in accordance with examples as disclosed herein. For example, the communications manager 520 may be configured as or otherwise support a means for monitoring for one or more semi-persistent scheduling transmissions in accordance with one or more semi-persistent scheduling configurations. The communications manager 520 may be configured as or otherwise support a means for generating a set of feedback bits associated with the one or more semi-persistent scheduling transmissions, the set of feedback bits scheduled for transmission to a network entity in a first set of uplink symbols. The communications manager 520 may be configured as or otherwise support a means for receiving control signaling that changes an availability of the first set of uplink symbols for transmission of the set of feedback bits. The communications manager 520 may be configured as or otherwise support a means for deferring transmission of the set of feedback bits to a second set of uplink symbols based on the receiving of the control signaling. The communications manager 520 may be configured as or otherwise support a means for determining whether to transmit at least a portion of the set of feedback bits in the second set of uplink symbols. The communications manager 520 may be configured as or otherwise support a means for communicating with the network entity in accordance with the determining.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for multiplexing uplink control information, which may reduce signaling overhead and power consumption among other advantages. Deferring collided SPS feedback based on different channel conditions and reducing the number of collisions may improve resource efficiency and user experience. As such, techniques described herein may improve network operations and, in some examples, may promote network efficiencies, among other benefits.

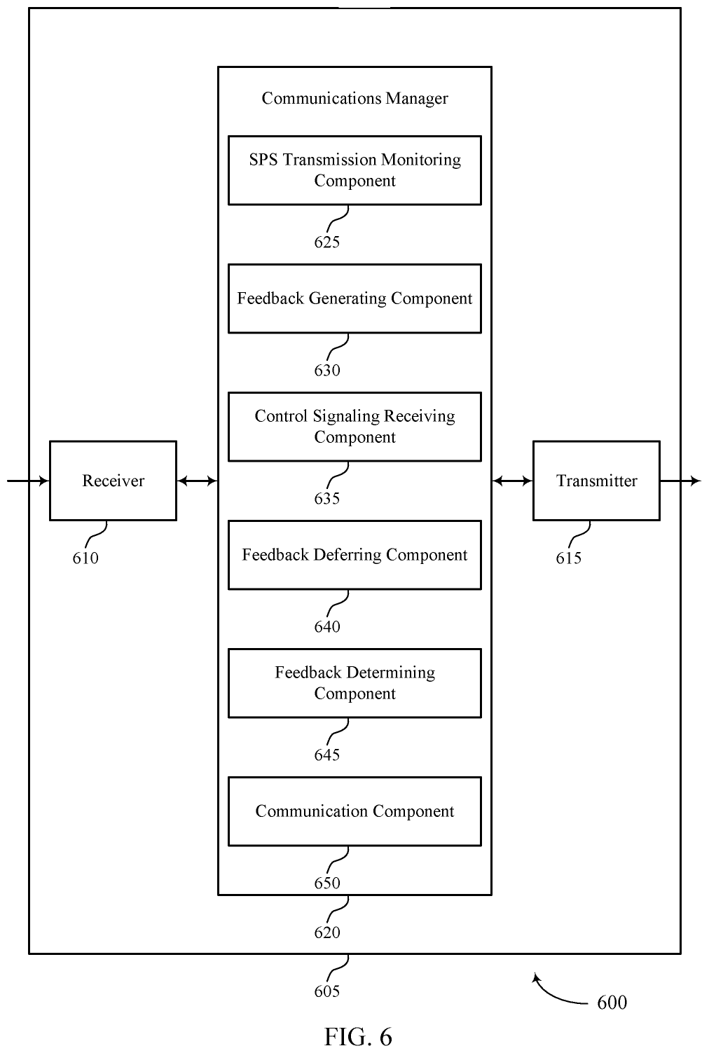

FIG. 6 shows a block diagram 600 of a device 605 that supports techniques for multiplexing uplink control information in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for multiplexing uplink control information). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for multiplexing uplink control information). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for multiplexing uplink control information as described herein. For example, the communications manager 620 may include an SPS transmission monitoring component 625, a feedback generating component 630, a control signaling receiving component 635, a feedback deferring component 640, a feedback determining component 645, a communication component 650, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a UE in accordance with examples as disclosed herein. The SPS transmission monitoring component 625 may be configured as or otherwise support a means for monitoring for one or more semi-persistent scheduling transmissions in accordance with one or more semi-persistent scheduling configurations. The feedback generating component 630 may be configured as or otherwise support a means for generating a set of feedback bits associated with the one or more semi-persistent scheduling transmissions, the set of feedback bits scheduled for transmission to a network entity in a first set of uplink symbols. The control signaling receiving component 635 may be configured as or otherwise support a means for receiving control signaling that changes an availability of the first set of uplink symbols for transmission of the set of feedback bits. The feedback deferring component 640 may be configured as or otherwise support a means for deferring transmission of the set of feedback bits to a second set of uplink symbols based on the receiving of the control signaling. The feedback determining component 645 may be configured as or otherwise support a means for determining whether to transmit at least a portion of the set of feedback bits in the second set of uplink symbols. The communication component 650 may be configured as or otherwise support a means for communicating with the network entity in accordance with the determining.

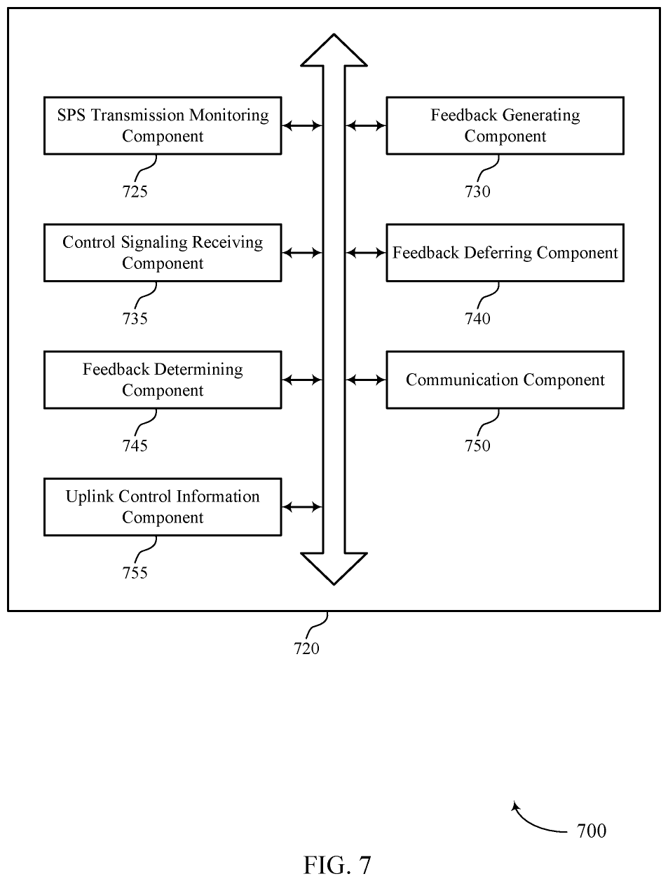

FIG. 7 shows a block diagram 700 of a communications manager 720 that supports techniques for multiplexing uplink control information in accordance with aspects of the present disclosure. The communications manager 720 may be an example of aspects of a communications manager 520, a communications manager 620, or both, as described herein. The communications manager 720, or various components thereof, may be an example of means for performing various aspects of techniques for multiplexing uplink control information as described herein. For example, the communications manager 720 may include an SPS transmission monitoring component 725, a feedback generating component 730, a control signaling receiving component 735, a feedback deferring component 740, a feedback determining component 745, a communication component 750, an uplink control information component 755, or any combination thereof. Each of these components may communicate, directly or indirectly, with one another (e.g., via one or more buses).

The communications manager 720 may support wireless communications at a UE in accordance with examples as disclosed herein. The SPS transmission monitoring component 725 may be configured as or otherwise support a means for monitoring for one or more semi-persistent scheduling transmissions in accordance with one or more semi-persistent scheduling configurations. The feedback generating component 730 may be configured as or otherwise support a means for generating a set of feedback bits associated with the one or more semi-persistent scheduling transmissions, the set of feedback bits scheduled for transmission to a network entity in a first set of uplink symbols. The control signaling receiving component 735 may be configured as or otherwise support a means for receiving control signaling that changes an availability of the first set of uplink symbols for transmission of the set of feedback bits. The feedback deferring component 740 may be configured as or otherwise support a means for deferring transmission of the set of feedback bits to a second set of uplink symbols based on the receiving of the control signaling. The feedback determining component 745 may be configured as or otherwise support a means for determining whether to transmit at least a portion of the set of feedback bits in the second set of uplink symbols. The communication component 750 may be configured as or otherwise support a means for transmitting at least the portion of the set of feedback bits in the second set of uplink symbols in accordance with the determining. The communication component 750 may be configured as or otherwise support a means for communicating with the network entity in accordance with the determining.

In some examples, the feedback determining component 745 may be configured as or otherwise support a means for determining that a size of the set of feedback bits is greater than a size of an allocation in the second set of uplink symbols for transmission of the set of feedback bits, where the determining whether to transmit at least the portion of the set of feedback bits in the second set of uplink symbols is based on the determining that the size of the set of feedback bits is greater than the size of the allocation in the second set of uplink symbols.

In some examples, the feedback deferring component 740 may be configured as or otherwise support a means for deferring transmission of the set of feedback bits to a third set of uplink symbols based on the size of the allocation.

In some examples, the communication component 750 may be configured as or otherwise support a means for transmitting at least the portion of the set of feedback bits in the second set of uplink symbols based on the size of the allocation.

In some examples, the uplink control information component 755 may be configured as or otherwise support a means for generating a set of uplink control information bits scheduled for transmission to the network entity in the second set of uplink symbols, where the determining whether to transmit at least the portion of the set of feedback bits in the second set of uplink symbols is based on generating the set of uplink control information bits.

In some examples, the communication component 750 may be configured as or otherwise support a means for transmitting at least the portion of the set of feedback bits and the set of uplink control information bits in the second set of uplink symbols based on generating the set of uplink control information bits.

In some examples, the feedback determining component 745 may be configured as or otherwise support a means for determining that a size of the set of feedback bits and the set of uplink control information bits is greater than a size of an allocation in the second set of uplink symbols for transmission of the set of feedback bits and the set of uplink control information bits. In some examples, the communication component 750 may be configured as or otherwise support a means for refraining from transmitting at least the portion of the set of feedback bits and the set of uplink control information bits in the second set of uplink symbols based on the determining that the size of the set of feedback bits and the set of uplink control information bits is greater than the size of the allocation, where the communicating with the network entity includes the refraining.

In some examples, the feedback deferring component 740 may be configured as or otherwise support a means for deferring transmission of the set of feedback bits and the set of uplink control information bits to a third set of uplink symbols based on the size of the allocation.

In some examples, the determining whether to transmit at least the portion of the set of feedback bits in the second set of uplink symbols is based on a type of the set of uplink control information bits.

In some examples, the communication component 750 may be configured as or otherwise support a means for transmitting the set of uplink control information bits in the second set of uplink symbols. In some examples, the feedback deferring component 740 may be configured as or otherwise support a means for deferring transmission of the set of feedback bits to a third set of uplink symbols based on generating the set of uplink control information bits.

In some examples, the communication component 750 may be configured as or otherwise support a means for transmitting at least the portion of the set of feedback bits in the second set of uplink symbols in accordance with the determining. In some examples, the feedback deferring component 740 may be configured as or otherwise support a means for deferring transmission of the set of uplink control information bits to a third set of uplink symbols based on transmitting at least the portion of the set of feedback bits in the second set of uplink symbols.

In some examples, the feedback deferring component 740 may be configured as or otherwise support a means for generating a compressed feedback bit based on generating the set of feedback bits, the compressed feedback bit associated with at least the portion of the set of feedback bits. In some examples, the communication component 750 may be configured as or otherwise support a means for transmitting the compressed feedback bit in the second set of uplink symbols based on generating the set of uplink control information bits.

In some examples, the feedback determining component 745 may be configured as or otherwise support a means for determining that the second set of uplink symbols occurs a quantity of slots after the first set of uplink symbols. In some examples, the communication component 750 may be configured as or otherwise support a means for refraining from transmitting at least the portion of the set of feedback bits in the second set of uplink symbols based on the quantity of slots, where the communicating with the network entity includes the refraining.

In some examples, each slot of the quantity of slots includes uplink symbols, flexible symbols, or both. In some examples, the flexible symbols are configured for transmission of uplink transmissions or downlink transmissions.

In some examples, the feedback determining component 745 may be configured as or otherwise support a means for determining an order of the set of feedback bits in a feedback codebook for transmission in the second set of uplink symbols, where determining whether to transmit at least the portion of the set of feedback bits in the second set of uplink symbols is based on the order of the set of feedback bits in the feedback codebook.

In some examples, the communication component 750 may be configured as or otherwise support a means for determining to transmit at least the portion of the set of feedback bits in the second set of uplink symbols based on the order of the set of feedback bits in the feedback codebook, wherein the feedback codebook is a first type of feedback codebook or a second type of feedback codebook that includes a concatenation of a set of feedback codebooks associated with the first set of uplink symbols. In some examples, the concatenation of the set of feedback codebooks is based on an order of the set of feedback codebooks in time.

In some examples, the feedback determining component 745 may be configured as or otherwise support a means for generating a feedback codebook based on a set of indices associated corresponding to a serving cell, the one or semi-persistent scheduling configurations, the first set of uplink symbols, and the second set of uplink symbols. In some examples, the communication component 750 may be configured as or otherwise support a means for determining to transmit at least the portion of the set of feedback bits in the second set of uplink symbols in accordance with the generated feedback codebook.

In some examples, the feedback determining component 745 may be configured as or otherwise support a means for generating a set of uplink control information bits and a feedback codebook scheduled for transmission to the network entity in the second set of uplink symbols, wherein determining whether to transmit at least the portion of the set of feedback bits in the second set of uplink symbols is based on generating the set of uplink control information bits and the feedback codebook, wherein the feedback codebook is a first type of feedback codebook or a second type of feedback codebook that includes a concatenation of a set of feedback codebooks associated with the first set of uplink symbols. In some examples, the communication component 750 may be configured as or otherwise support a means for transmitting at least the portion of the set of feedback bits and the set of uplink control information bits in the second set of uplink symbols based on generating the set of uplink control information bits and in accordance with the feedback codebook.

In some examples, the feedback deferring component 740 may be configured as or otherwise support a means for deferring transmission of the set of feedback bits to a third set of uplink symbols, wherein an allocation in the third set of uplink symbols for transmission of the set of feedback bits overlaps with one or more scheduled downlink transmissions, and wherein an offset between the allocation and the one or more scheduled downlink transmissions satisfies a threshold.

In some examples, the communication component 750 may be configured as or otherwise support a means for refraining from transmitting at least a portion of the set of feedback bits in the third set of uplink symbols based on the overlapping one or more scheduled downlink transmissions, wherein communicating with the network entity includes the refraining.

In some examples, the feedback deferring component 740 may be configured as or otherwise support a means for deferring transmission of the set of feedback bits to a third set of uplink symbols, wherein an allocation in the third set of uplink symbols includes a second set of feedback bits for a dynamic grant. In some examples, the communication component 750 may be configured as or otherwise support a means for refraining from transmitting at least a portion of the set of feedback bits in the third set of uplink symbols based on the deferring.

In some examples, the feedback deferring component 740 may be configured as or otherwise support a means for deferring transmission of the set of feedback bits to a third set of uplink symbols, wherein the set of feedback bits are associated with an uplink dynamic grant and wherein an allocation in the third set of uplink symbols includes a second set of feedback bits associated with a downlink dynamic grant.

In some examples, the feedback determining component 745 may be configured as or otherwise support a means for determining that an allocation of a third set of uplink symbols is non-overlapping with a symbols corresponding to a control resource set. In some examples, feedback deferring component 740 may be configured as or otherwise support a means for deferring transmission of the set of feedback bits to a third set of uplink symbols based on the determining.

In some examples, feedback determining component 745 may be configured as or otherwise support a means for determining that a size of the set of feedback bits is greater than a size of an allocation in the second set of uplink symbols for transmission of the set of feedback bits, wherein the determining whether to transmit at least the portion of the set of feedback bits in the second set of uplink symbols is based on the determining that the size of the set of feedback bits is greater than the size of the allocation in the second set of uplink symbols.

In some examples, the feedback determining component 745 may be configured as or otherwise support a means for determining that the second set of uplink symbols occurs a quantity of symbols after the first set of uplink symbols. In some examples, the communication component 750 may be configured as or otherwise support a means for refraining from transmitting at least the portion of the set of feedback bits in the second set of uplink symbols based on the quantity of symbols, where the communicating with the network entity includes the refraining.

In some examples, the feedback determining component 745 may be configured as or otherwise support a means for determining a respective priority associated with each feedback bit of the set of feedback bits. In some examples, the communication component 750 may be configured as or otherwise support a means for transmitting at least the portion of the set of feedback bits in the second set of uplink symbols in accordance with the determining the respective priorities.

In some examples, the control signaling indicates that the first set of uplink symbols at least partially overlap with a set of downlink symbols, a set of synchronization signal block symbols, or both.

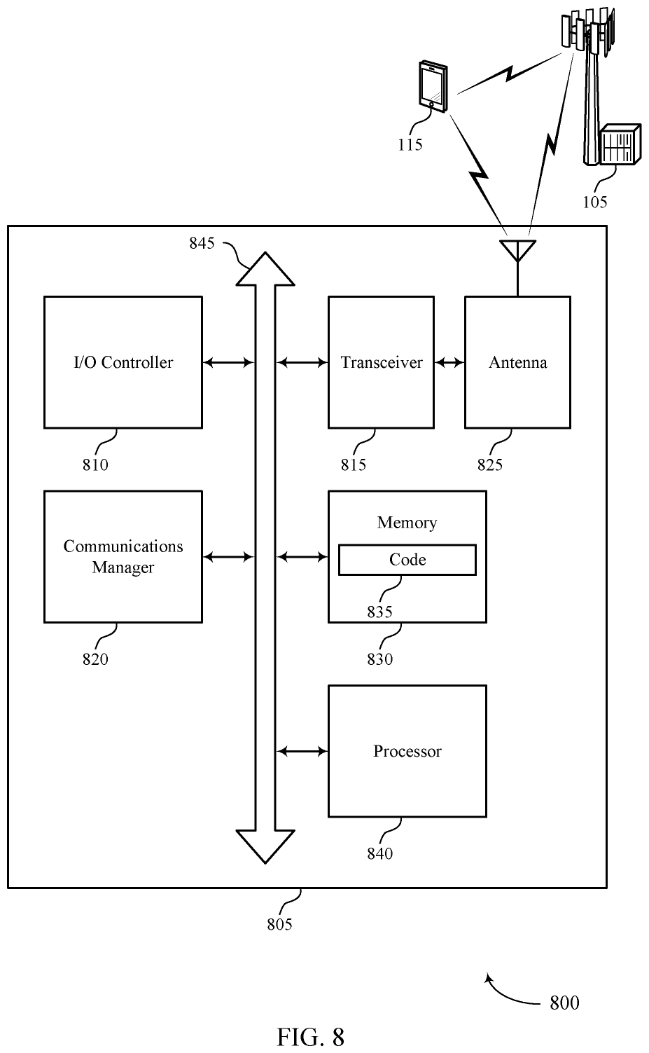

FIG. 8 shows a diagram of a system 800 including a device 805 that supports techniques for multiplexing uplink control information in accordance with aspects of the present disclosure. The device 805 may be an example of or include the components of a device 505, a device 605, or a UE 115 as described herein. The device 805 may communicate wirelessly with one or more network entities 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting techniques for multiplexing uplink control information). For example, the device 805 or a component of the device 805 may include a processor 840 and memory 830 coupled to the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for monitoring for one or more semi-persistent scheduling transmissions in accordance with one or more semi-persistent scheduling configurations. The communications manager 820 may be configured as or otherwise support a means for generating a set of feedback bits associated with the one or more semi-persistent scheduling transmissions, the set of feedback bits scheduled for transmission to a network entity in a first set of uplink symbols. The communications manager 820 may be configured as or otherwise support a means for receiving control signaling that changes an availability of the first set of uplink symbols for transmission of the set of feedback bits. The communications manager 820 may be configured as or otherwise support a means for deferring transmission of the set of feedback bits to a second set of uplink symbols based on the receiving of the control signaling. The communications manager 820 may be configured as or otherwise support a means for determining whether to transmit at least a portion of the set of feedback bits in the second set of uplink symbols. The communications manager 820 may be configured as or otherwise support a means for communicating with the network entity in accordance with the determining.

By including or configuring the communications manager 820 in accordance with examples as described herein, the device 805 may support techniques for multiplexing uplink control information, which may reduce signaling overhead and power consumption among other advantages. Deferring collided SPS feedback based on different channel conditions and reducing the number of collisions may improve resource efficiency and user experience. As such, techniques described herein may improve network operations and, in some examples, may promote network efficiencies, among other benefits.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of techniques for multiplexing uplink control information as described herein, or the processor 840 and the memory 830 may be otherwise configured to perform or support such operations.

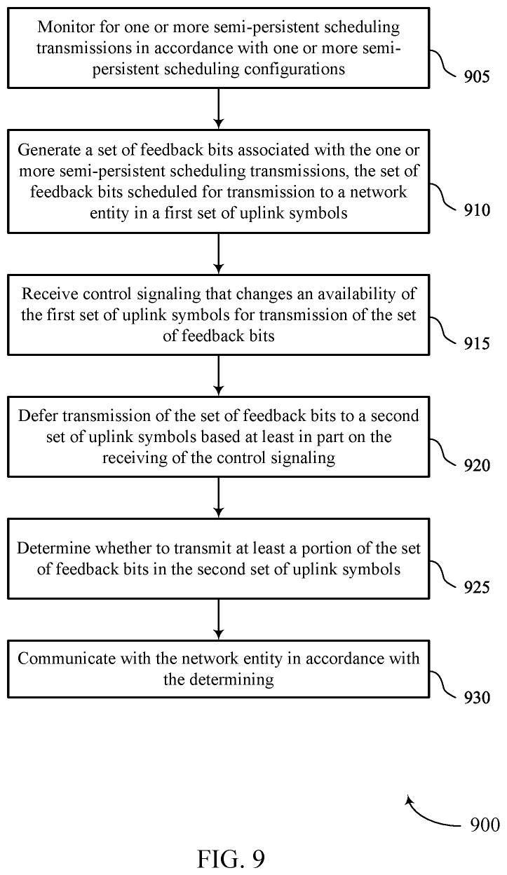

FIG. 9 shows a flowchart illustrating a method 900 that supports techniques for multiplexing uplink control information in accordance with aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include monitoring for one or more semi-persistent scheduling transmissions in accordance with one or more semi-persistent scheduling configurations. The operations of 905 may be performed in accordance with examples as disclosed herein. In some examples, aspects of the operations of 905 may be performed by an SPS transmission monitoring component 725 as described with reference to FIG. 7.

At 910, the method may include generating a set of feedback bits associated with the one or more semi-persistent scheduling transmissions, the set of feedback bits scheduled for transmission to a network entity in a first set of uplink symbols. The operations of 910 may be performed in accordance with examples as disclosed herein. In some examples, aspects of the operations of 910 may be performed by a feedback generating component 730 as described with reference to FIG. 7.

At 915, the method may include receiving control signaling that changes an availability of the first set of uplink symbols for transmission of the set of feedback bits. The operations of 915 may be performed in accordance with examples as disclosed herein. In some examples, aspects of the operations of 915 may be performed by a control signaling receiving component 735 as described with reference to FIG. 7.

At 920, the method may include deferring transmission of the set of feedback bits to a second set of uplink symbols based at least in part on the receiving of the control signaling. The operations of 920 may be performed in accordance with examples as disclosed herein. In some examples, aspects of the operations of 920 may be performed by a feedback deferring component 740 as described with reference to FIG. 7.

At 925, the method may include determining whether to transmit at least a portion of the set of feedback bits in the second set of uplink symbols. The operations of 925 may be performed in accordance with examples as disclosed herein. In some examples, aspects of the operations of 925 may be performed by a feedback determining component 745 as described with reference to FIG. 7.

At 930, the method may include communicating with the network entity in accordance with the determining. The operations of 930 may be performed in accordance with examples as disclosed herein. In some examples, aspects of the operations of 930 may be performed by a communication component 750 as described with reference to FIG. 7.

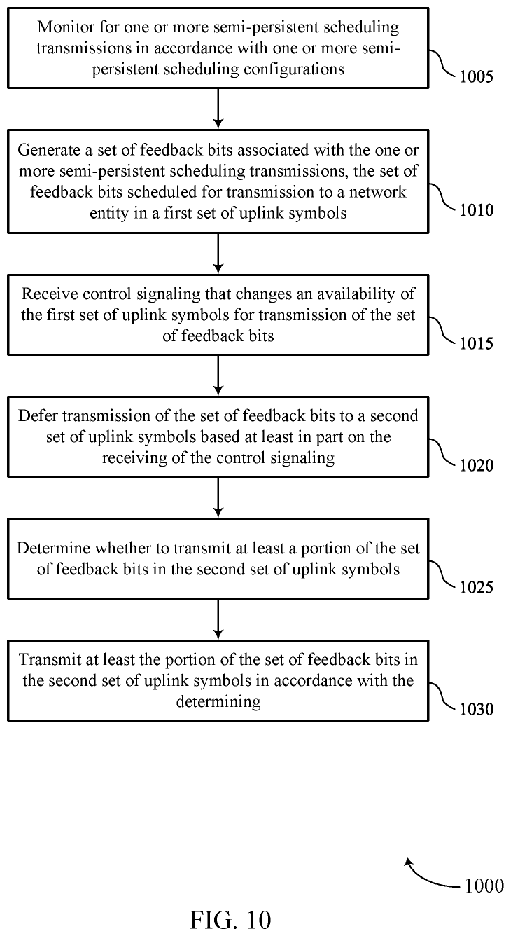

FIG. 10 shows a flowchart illustrating a method 1000 that supports techniques for multiplexing uplink control information in accordance with aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include monitoring for one or more semi-persistent scheduling transmissions in accordance with one or more semi-persistent scheduling configurations. The operations of 1005 may be performed in accordance with examples as disclosed herein. In some examples, aspects of the operations of 1005 may be performed by an SPS transmission monitoring component 725 as described with reference to FIG. 7.

At 1010, the method may include generating a set of feedback bits associated with the one or more semi-persistent scheduling transmissions, the set of feedback bits scheduled for transmission to a network entity in a first set of uplink symbols. The operations of 1010 may be performed in accordance with examples as disclosed herein. In some examples, aspects of the operations of 1010 may be performed by a feedback generating component 730 as described with reference to FIG. 7.

At 1015, the method may include receiving control signaling that changes an availability of the first set of uplink symbols for transmission of the set of feedback bits. The operations of 1015 may be performed in accordance with examples as disclosed herein. In some examples, aspects of the operations of 1015 may be performed by a control signaling receiving component 735 as described with reference to FIG. 7.

At 1020, the method may include deferring transmission of the set of feedback bits to a second set of uplink symbols based at least in part on the receiving of the control signaling. The operations of 1020 may be performed in accordance with examples as disclosed herein. In some examples, aspects of the operations of 1020 may be performed by a feedback deferring component 740 as described with reference to FIG. 7.

At 1025, the method may include determining whether to transmit at least a portion of the set of feedback bits in the second set of uplink symbols. The operations of 1025 may be performed in accordance with examples as disclosed herein. In some examples, aspects of the operations of 1025 may be performed by a feedback determining component 745 as described with reference to FIG. 7.

At 1030, the method may include transmitting at least the portion of the set of feedback bits in the second set of uplink symbols in accordance with the determining. The operations of 1030 may be performed in accordance with examples as disclosed herein. In some examples, aspects of the operations of 1030 may be performed by a communication component 750 as described with reference to FIG. 7.

The following provides an overview of aspects of the present disclosure:

Aspect 1: A method for wireless communications at a UE, comprising: monitoring for one or more semi-persistent scheduling transmissions in accordance with one or more semi-persistent scheduling configurations; generating a set of feedback bits associated with the one or more semi-persistent scheduling transmissions, the set of feedback bits scheduled for transmission to a network entity in a first set of uplink symbols; receiving control signaling that changes an availability of the first set of uplink symbols for transmission of the set of feedback bits; deferring transmission of the set of feedback bits to a second set of uplink symbols based at least in part on the receiving of the control signaling; determining whether to transmit at least a portion of the set of feedback bits in the second set of uplink symbols; transmitting at least the portion of the set of feedback bits in the second set of uplink symbols in accordance with the determining; and communicating with the network entity in accordance with the determining.

Aspect 2: The method of aspect 1, further comprising: determining that a size of the set of feedback bits is greater than a size of an allocation in the second set of uplink symbols for transmission of the set of feedback bits, wherein the determining whether to transmit at least the portion of the set of feedback bits in the second set of uplink symbols is based at least in part on the determining that the size of the set of feedback bits is greater than the size of the allocation in the second set of uplink symbols.

Aspect 3: The method of aspect 2, further comprising: deferring transmission of the set of feedback bits to a third set of uplink symbols based at least in part on the size of the allocation.

Aspect 4: The method of any of aspects 3 through 3, further comprising: transmitting at least the portion of the set of feedback bits in the second set of uplink symbols based at least in part on the size of the allocation.

Aspect 5: The method of any of aspects 1 through 4, further comprising: generating a set of uplink control information bits scheduled for transmission to the network entity in the second set of uplink symbols, wherein the determining whether to transmit at least the portion of the set of feedback bits in the second set of uplink symbols is based at least in part on generating the set of uplink control information bits.

Aspect 6: The method of aspect 5, further comprising: transmitting at least the portion of the set of feedback bits and the set of uplink control information bits in the second set of uplink symbols based at least in part on generating the set of uplink control information bits.

Aspect 7: The method of any of aspects 5 through 6, further comprising: determining that a size of the set of feedback bits and the set of uplink control information bits is greater than a size of an allocation in the second set of uplink symbols for transmission of the set of feedback bits and the set of uplink control information bits; and refraining from transmitting at least the portion of the set of feedback bits and the set of uplink control information bits in the second set of uplink symbols based at least in part on the determining that the size of the set of feedback bits and the set of uplink control information bits is greater than the size of the allocation, wherein the communicating with the network entity comprises the refraining.

Aspect 8: The method of aspect 7, further comprising: deferring transmission of the set of feedback bits and the set of uplink control information bits to a third set of uplink symbols based at least in part on the size of the allocation.

Aspect 9: The method of any of the aspects 5 through 8, wherein the determining whether to transmit at least the portion of the set of feedback bits in the second set of uplink symbols is based at least in part on a type of the set of uplink control information bits.

Aspect 10: The method of any of aspects 5 through 9, further comprising: transmitting the set of uplink control information bits in the second set of uplink symbols; and deferring transmission of the set of feedback bits to a third set of uplink symbols based at least in part on generating the set of uplink control information bits.

Aspect 11: The method of any of aspects 5 through 10, further comprising: transmitting at least the portion of the set of feedback bits in the second set of uplink symbols in accordance with the determining; and deferring transmission of the set of uplink control information bits to a third set of uplink symbols based at least in part on transmitting at least the portion of the set of feedback bits in the second set of uplink symbols.

Aspect 12: The method of any of aspects 5 through 11, further comprising: generating a compressed feedback bit based at least in part on generating the set of feedback bits, the compressed feedback bit associated with at least the portion of the set of feedback bits; and transmitting the compressed feedback bit in the second set of uplink symbols based at least in part on generating the set of uplink control information bits.

Aspect 13: The method of any of aspects 1 through 12, further comprising: determining that the second set of uplink symbols occurs a quantity of slots after the first set of uplink symbols; and refraining from transmitting at least the portion of the set of feedback bits in the second set of uplink symbols based at least in part on the quantity of slots, wherein the communicating with the network entity comprises the refraining.

Aspect 14: The method of aspect 13, wherein each slot of the quantity of slots comprises uplink symbols, flexible symbols, or both, and the flexible symbols are configured for transmission of uplink transmissions or downlink transmissions.

Aspect 15: The method of any of aspects 1 through 14, further comprising: determining an order of the set of feedback bits in a feedback codebook for transmission in the second set of uplink symbols, wherein determining whether to transmit at least the portion of the set of feedback bits in the second set of uplink symbols is based at least in part on the order of the set of feedback bits in the feedback codebook.

Aspect 16: The method of any of aspects 1 through 15, further comprising: determining to transmit at least the portion of the set of feedback bits in the second set of uplink symbols based at least in part on the order of the set of feedback bits in the feedback codebook, wherein the feedback codebook is a first type of feedback codebook or a second type of feedback codebook that comprises a concatenation of a plurality of feedback codebooks associated with the first set of uplink symbols.

Aspect 17: The method of aspect 16, wherein the concatenation of the plurality of feedback codebooks is based at least in part on an order of the plurality of feedback codebooks in time.

Aspect 18: The method of any of aspects 15 through 17, further comprising: generating a feedback codebook based at least in part on a set of indices associated corresponding to a serving cell, the one or semi-persistent scheduling configurations, the first set of uplink symbols, and the second set of uplink symbols; and determining to transmit at least the portion of the set of feedback bits in the second set of uplink symbols in accordance with the generated feedback codebook.

Aspect 19: The method of any of aspects 1 through 18, further comprising: generating a set of uplink control information bits and a feedback codebook scheduled for transmission to the network entity in the second set of uplink symbols, wherein determining whether to transmit at least the portion of the set of feedback bits in the second set of uplink symbols is based at least in part on generating the set of uplink control information bits and the feedback codebook, wherein the feedback codebook is a first type of feedback codebook or a second type of feedback codebook that comprises a concatenation of a plurality of feedback codebooks associated with the first set of uplink symbols; and transmitting at least the portion of the set of feedback bits and the set of uplink control information bits in the second set of uplink symbols based at least in part on generating the set of uplink control information bits and in accordance with the feedback codebook.

Aspect 20: The method of any of aspects 1 through 19, further comprising: deferring transmission of the set of feedback bits to a third set of uplink symbols, wherein an allocation in the third set of uplink symbols for transmission of the set of feedback bits overlaps with one or more scheduled downlink transmissions, and wherein an offset between the allocation and the one or more scheduled downlink transmissions satisfies a threshold.

Aspect 21: the method of aspect 20, further comprising: refraining from transmitting at least a portion of the set of feedback bits in the third set of uplink symbols based at least in part on the overlapping one or more scheduled downlink transmissions, wherein communicating with the network entity comprises the refraining.

Aspect 22: The method of any of aspects 1 through 21, further comprising: deferring transmission of the set of feedback bits to a third set of uplink symbols, wherein an allocation in the third set of uplink symbols comprises a second set of feedback bits for a DG; and refraining from transmitting at least a portion of the set of feedback bits in the third set of uplink symbols based at least in part on the deferring.

Aspect 23: The method of any of aspects 1 through 22, further comprising: deferring transmission of the set of feedback bits to a third set of uplink symbols, wherein the set of feedback bits are associated with an uplink DG and wherein an allocation in the third set of uplink symbols comprises a second set of feedback bits associated with a downlink DG.

Aspect 24: The method of any of aspects 1 through 23, further comprising: determining that an allocation of a third set of uplink symbols is non-overlapping with a symbols corresponding to a control resource set; and deferring transmission of the set of feedback bits to a third set of uplink symbols based at least in part on the determining.

Aspect 25: The method of any of aspects 1 through 24, further comprising: determining that a size of the set of feedback bits is greater than a size of an allocation in the second set of uplink symbols for transmission of the set of feedback bits, wherein the determining whether to transmit at least the portion of the set of feedback bits in the second set of uplink symbols is based at least in part on the determining that the size of the set of feedback bits is greater than the size of the allocation in the second set of uplink symbols.

Aspect 26: The method of any of aspects 1 through 25, further comprising: determining that the second set of uplink symbols occurs a quantity of symbols after the first set of uplink symbols; and refraining from transmitting at least the portion of the set of feedback bits in the second set of uplink symbols based at least in part on the quantity of symbols, wherein the communicating with the network entity comprises the refraining.

Aspect 27: The method of any of aspects 1 through 26, further comprising: determining a respective priority associated with each feedback bit of the set of feedback bits; and transmitting at least the portion of the set of feedback bits in the second set of uplink symbols in accordance with the determining the respective priorities.

Aspect 28: The method of any of aspects 1 through 27, wherein the control signaling indicates that the first set of uplink symbols at least partially overlap with a set of downlink symbols, a set of synchronization signal block symbols, or both.

Aspect 29: An apparatus for wireless communications at a UE, comprising at least one processor; and memory coupled with the at least one processor; and the memory storing instructions executable by the at least one processor to cause the apparatus or the UE to perform a method of any of aspects 1 through 28.

Aspect 30: An apparatus for wireless communications at a UE, comprising at least one means for performing a method of any of aspects 1 through 28.

Aspect 31: A non-transitory computer-readable medium storing code for wireless communications at a UE, the code comprising instructions executable by at least one processor to perform a method of any of aspects 1 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software (e.g., executed by a processor), or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
monitoring for one or more semi-persistent scheduling transmissions in accordance with one or more semi-persistent scheduling configurations;
generating a set of feedback bits associated with the one or more semi-persistent scheduling transmissions, the set of feedback bits scheduled for transmission to a network entity in a first set of uplink symbols;
receiving control signaling that changes an availability of the first set of uplink symbols for transmission of the set of feedback bits;
deferring transmission of the set of feedback bits to a second set of uplink symbols based at least in part on the receiving of the control signaling;
determining whether to transmit at least a portion of the set of feedback bits in the second set of uplink symbols;
transmitting at least the portion of the set of feedback bits in the second set of uplink symbols in accordance with the determining; and
communicating with the network entity in accordance with the determining.

2. The method of claim 1, further comprising:
determining that a size of the set of feedback bits is greater than a size of an allocation in the second set of uplink symbols for transmission of the set of feedback bits, wherein the determining whether to transmit at least the portion of the set of feedback bits in the second set of uplink symbols is based at least in part on the determining that the size of the set of feedback bits is greater than the size of the allocation in the second set of uplink symbols.

3. The method of claim 2, further comprising:
deferring transmission of the set of feedback bits to a third set of uplink symbols based at least in part on the size of the allocation.

4. The method of claim 2, further comprising:
transmitting at least the portion of the set of feedback bits in the second set of uplink symbols based at least in part on the size of the allocation.

5. The method of claim 1, further comprising:
generating a set of uplink control information bits scheduled for transmission to the network entity in the second set of uplink symbols, wherein the determining whether to transmit at least the portion of the set of feedback bits in the second set of uplink symbols is based at least in part on generating the set of uplink control information bits.

6. The method of claim 5, further comprising:
transmitting at least the portion of the set of feedback bits and the set of uplink control information bits in the second set of uplink symbols based at least in part on generating the set of uplink control information bits.

7. The method of claim 5, further comprising:
determining that a size of the set of feedback bits and the set of uplink control information bits is greater than a size of an allocation in the second set of uplink symbols for transmission of the set of feedback bits and the set of uplink control information bits; and
refraining from transmitting at least the portion of the set of feedback bits and the set of uplink control information bits in the second set of uplink symbols based at least in part on the determining that the size of the set of feedback bits and the set of uplink control information bits is greater than the size of the allocation, wherein the communicating with the network entity comprises the refraining.

8. The method of claim 7, further comprising:
deferring transmission of the set of feedback bits and the set of uplink control information bits to a third set of uplink symbols based at least in part on the size of the allocation.

9. The method of claim 5, wherein the determining whether to transmit at least the portion of the set of feedback bits in the second set of uplink symbols is based at least in part on a type of the set of uplink control information bits.

10. The method of claim 5, further comprising:
transmitting the set of uplink control information bits in the second set of uplink symbols; and
deferring transmission of the set of feedback bits to a third set of uplink symbols based at least in part on generating the set of uplink control information bits.

11. The method of claim 5, further comprising:
transmitting at least the portion of the set of feedback bits in the second set of uplink symbols in accordance with the determining; and
deferring transmission of the set of uplink control information bits to a third set of uplink symbols based at least in part on transmitting at least the portion of the set of feedback bits in the second set of uplink symbols.

12. The method of claim 5, further comprising:
generating a compressed feedback bit based at least in part on generating the set of feedback bits, the compressed feedback bit associated with at least the portion of the set of feedback bits; and
transmitting the compressed feedback bit in the second set of uplink symbols based at least in part on generating the set of uplink control information bits.

13. The method of claim 1, further comprising:
determining that the second set of uplink symbols occurs a quantity of slots after the first set of uplink symbols; and
refraining from transmitting at least the portion of the set of feedback bits in the second set of uplink symbols based at least in part on the quantity of slots, wherein the communicating with the network entity comprises the refraining.

14. The method of claim 13, wherein:
each slot of the quantity of slots comprises uplink symbols, flexible symbols, or both, and
the flexible symbols are configured for transmission of uplink transmissions or downlink transmissions.

15. The method of claim 1, further comprising:
determining an order of the set of feedback bits in a feedback codebook for transmission in the second set of uplink symbols, wherein determining whether to transmit at least the portion of the set of feedback bits in the second set of uplink symbols is based at least in part on the order of the set of feedback bits in the feedback codebook.

16. The method of claim 15, further comprising:
determining to transmit at least the portion of the set of feedback bits in the second set of uplink symbols based at least in part on the order of the set of feedback bits in the feedback codebook, wherein the feedback codebook is a first type of feedback codebook or a second type of feedback codebook that comprises a concatenation of a plurality of feedback codebooks associated with the first set of uplink symbols.

17. The method of claim 16, wherein the concatenation of the plurality of feedback codebooks is based at least in part on an order of the plurality of feedback codebooks in time.

18. The method of claim 15, further comprising:
generating a feedback codebook based at least in part on a set of indices associated corresponding to a serving cell, the one or semi-persistent scheduling configurations, the first set of uplink symbols, and the second set of uplink symbols; and
determining to transmit at least the portion of the set of feedback bits in the second set of uplink symbols in accordance with the generated feedback codebook.

19. The method of claim 1, further comprising:
generating a set of uplink control information bits and a feedback codebook scheduled for transmission to the network entity in the second set of uplink symbols, wherein determining whether to transmit at least the portion of the set of feedback bits in the second set of uplink symbols is based at least in part on generating the set of uplink control information bits and the feedback codebook, wherein the feedback codebook is a first type of feedback codebook or a second type of feedback codebook that comprises a concatenation of a plurality of feedback codebooks associated with the first set of uplink symbols; and
transmitting at least the portion of the set of feedback bits and the set of uplink control information bits in the second set of uplink symbols based at least in part on generating the set of uplink control information bits and in accordance with the feedback codebook.

20. The method of claim 1, further comprising:
deferring transmission of the set of feedback bits to a third set of uplink symbols, wherein an allocation in the third set of uplink symbols for transmission of the set of feedback bits overlaps with one or more scheduled downlink transmissions, and wherein an offset between the allocation and the one or more scheduled downlink transmissions satisfies a threshold.

21. The method of claim 20, further comprising:
refraining from transmitting at least a portion of the set of feedback bits in the third set of uplink symbols based at least in part on the overlapping one or more scheduled downlink transmissions, wherein communicating with the network entity comprises the refraining.

22. The method of claim 1, further comprising:
deferring transmission of the set of feedback bits to a third set of uplink symbols, wherein an allocation in the third set of uplink symbols comprises a second set of feedback bits for a dynamic grant; and
refraining from transmitting at least a portion of the set of feedback bits in the third set of uplink symbols based at least in part on the deferring.

23. The method of claim 1, further comprising:
deferring transmission of the set of feedback bits to a third set of uplink symbols, wherein the set of feedback bits are associated with an uplink dynamic grant and wherein an allocation in the third set of uplink symbols comprises a second set of feedback bits associated with a downlink dynamic grant.

24. The method of claim 1, further comprising:
determining that an allocation of a third set of uplink symbols is non-overlapping with a symbols corresponding to a control resource set; and
deferring transmission of the set of feedback bits to a third set of uplink symbols based at least in part on the determining.

25. The method of claim 1, further comprising:
determining that a size of the set of feedback bits is greater than a size of an allocation in the second set of uplink symbols for transmission of the set of feedback bits, wherein the determining whether to transmit at least the portion of the set of feedback bits in the second set of uplink symbols is based at least in part on the determining that the size of the set of feedback bits is greater than the size of the allocation in the second set of uplink symbols.

26. The method of claim 1, further comprising:
determining that the second set of uplink symbols occurs a quantity of symbols after the first set of uplink symbols; and
refraining from transmitting at least the portion of the set of feedback bits in the second set of uplink symbols based at least in part on the quantity of symbols, wherein the communicating with the network entity comprises the refraining.

27. The method of claim 1, further comprising:
determining a respective priority associated with each feedback bit of the set of feedback bits; and
transmitting at least the portion of the set of feedback bits in the second set of uplink symbols in accordance with the determining the respective priorities.

28. An apparatus for wireless communications at a user equipment (UE), comprising:
at least one processor; and
memory coupled with the at least one processor; the memory storing instructions executable by the at least one processor to cause the UE to:
monitor for one or more semi-persistent scheduling transmissions in accordance with one or more semi-persistent scheduling configurations;
generate a set of feedback bits associated with the one or more semi-persistent scheduling transmissions, the set of feedback bits scheduled for transmission to a network entity in a first set of uplink symbols;
receive control signaling that changes an availability of the first set of uplink symbols for transmission of the set of feedback bits;
defer transmission of the set of feedback bits to a second set of uplink symbols based at least in part on the receiving of the control signaling;
determine whether to transmit at least a portion of the set of feedback bits in the second set of uplink symbols;
transmit at least the portion of the set of feedback bits in the second set of uplink symbols in accordance with the determining; and
communicate with the network entity in accordance with the determining.

29. An apparatus for wireless communications at a user equipment (UE), comprising:
means for monitoring for one or more semi-persistent scheduling transmissions in accordance with one or more semi-persistent scheduling configurations;
means for generating a set of feedback bits associated with the one or more semi-persistent scheduling transmissions, the set of feedback bits scheduled for transmission to a network entity in a first set of uplink symbols;
means for receiving control signaling that changes an availability of the first set of uplink symbols for transmission of the set of feedback bits;
means for deferring transmission of the set of feedback bits to a second set of uplink symbols based at least in part on the receiving of the control signaling;
means for determining whether to transmit at least a portion of the set of feedback bits in the second set of uplink symbols;
means for transmitting at least the portion of the set of feedback bits in the second set of uplink symbols in accordance with the determining; and
means for communicating with the network entity in accordance with the determining.

30. A non-transitory computer-readable medium storing code for wireless communications at a user equipment (UE), the code comprising instructions executable by at least one processor to:
monitor for one or more semi-persistent scheduling transmissions in accordance with one or more semi-persistent scheduling configurations;
generate a set of feedback bits associated with the one or more semi-persistent scheduling transmissions, the set of feedback bits scheduled for transmission to a network entity in a first set of uplink symbols;
receive control signaling that changes an availability of the first set of uplink symbols for transmission of the set of feedback bits;
defer transmission of the set of feedback bits to a second set of uplink symbols based at least in part on the receiving of the control signaling;
determine whether to transmit at least a portion of the set of feedback bits in the second set of uplink symbols;
transmit at least the portion of the set of feedback bits in the second set of uplink symbols in accordance with the determining; and
communicate with the network entity in accordance with the determining.
